(19) United States
(12) Patent Application Publication
(10) Pub. No.: US 2007/0177523 A1
(43) Pub. Date: Aug. 2, 2007

(54) System and method for network monitoring

(75) Inventors: Kenichi Nagami, Tokyo (JP); Ikuo Nakagawa, Tokyo (JP)

Correspondence Address: BIRCH STEWART KOLASCH & BIRCH, PO BOX 747, FALLS CHURCH, VA, 22040-0747, US

(73) Assignee: Intec NetCore, Inc.

(21) Appl. No.: 11/699,512

(22) Filed: Jan. 30, 2007

(30) Foreign Application Priority Data
Jan. 31, 2006 (JP) 2006-023903
Mar. 9, 2006 (JP) 2006-064942

(51) Int. Cl. H04J 1/16

(52) U.S. Cl. 370/252; 370/242; 370/238

(57) ABSTRACT

A network monitoring tool capable of effectively supporting a network administrator is provided. A monitoring apparatus includes a collecting unit that collects information on a network, a receiving unit that receives a notification indicating that an event has occurred on an element of the network, and an analyzing unit that analyzes correlation between one received notification and another received or potential notification on the basis of the collected information. The collecting unit may collect information regarding a packet forwarding path that is dynamically established in the network. The apparatus may further include a unit that detects whether the potential notification specified by the analyzing unit is actually received.

### BACKGROUND OF THE INVENTION

1. Field of the Invention

The present invention relates to an apparatus and method for monitoring a network such as the Internet and, in particular, to a technique of analyzing the correlation between many event notifications about related network elements that are successively issued due to an event occurred in a network.

2. Background

Network administrators typically use a network monitoring tool in order to detect network failures early and take appropriate actions such as repair or replacement of failed parts. If any of many nodes (network devices such as routers, gateways, hosts, terminal servers, and Ethernet switches) making up the network detects a state change (an event), the network monitoring tool issues a notification indicating the occurrence of the event and a network administrator's computer (a monitoring apparatus) receives the notification. The event may be a failure or a recovery from a failure, for example.

Such an event notification function can be implemented by using SNMP (Simple Network Management Protocol) traps, for example, if a manager program of the SNMP is running on the monitoring apparatus and an agent program of the SNMP resides on appropriate nodes in the network. The event notification function can also be implemented by monitoring a syslog or a route control protocol such as OSPF (Open Shortest Path First) or BGP (Border Gateway Protocol).

In network monitoring described above, one failure generates multiple failure notifications (alarms). For example, if a failure occurs in a circuit board in a router, failure notifications of ports connecting to the board are sent as well as a notification of the failure in the board. Thus, multiple failure notifications arrive at the monitoring apparatus as a result of the single failure. The network administrator (the user of the monitoring apparatus) then must locate a single point of failure to be resolved in the network from information in the multiple failure notifications. This task places a heavy load on the network administrator.

A method for automatically locating a failed part has been proposed (Japanese Patent Laid-Open No. 7-192188). In this method, a large number of alarms are divided into groups of related alarms according to synchronism in a occurrence log of the multiple alarms, learning is performed for associating a pattern of occurrence of the alarms in a group with an alarm that is in the closest relation among the alarms in the group to a phenomenon that occurred, and if alarms falling under the learned pattern occur, the alarm in the closest relation is selected and the other alarms are inhibited.

Another method has been disclosed (Japanese Patent Laid-Open No. 9-307550) so that the correlation can be analyzed even if the nodes are not in time-synchronization with one another. In this method, a large number of alarms are classified into categories, the time interval between occurrence of one alarm that belongs to one category and occurrence of another alarm that belongs to another category is analyzed to extract regularity of occurrence of alarms, and a representative alarm is extracted from among the large number of alarms on the basis of the regularity.

Yet another method has been proposed (Japanese Patent Laid-Open No. 9-64971) in which an algorithm based on physical connections in a network or empirical knowledge is used to associate a large number of alarms with one another, thereby improving the speed of correlation processing to find the cause of a problem.

While operating the network, a network administrator shuts down a part of the network in order to reconfigure the network, and add or replace devices or perform other maintenances. The network monitoring tool detects such maintenances as failures and the monitoring apparatus receives alarms. Consequently, alarms presented on the monitoring apparatus to the user (the network administrator) include those caused by scheduled maintenances as well as unexpected failures indistinguishably. The network administrator does not have to address alarms of the former type but, for alarms of the latter type, need take failure recovery actions.

Under such circumstances, the network administrator checks each alarm against a list of scheduled maintenances to decide whether the alarm has been caused by a failure to be addressed. A technique therefore has been proposed (Japanese Patent Laid-Open No. 9-168010) in which periods of scheduled maintenances and devices to be serviced by the maintenances are managed to prevent alarm events occurring on those devices in those periods from being reported to the operator (the network administrator).

### SUMMARY OF THE INVENTION

According to systems and methods consistent with the invention, a network monitoring tool for more effectively supporting a network administrator can be provided.

Systems and methods consistent with the invention may provide an apparatus that comprises: a collecting unit that collects information regarding a packet forwarding path, the path being dynamically established in a network; a receiving unit that receives a notification indicating that an event has occurred on an element of the network; and an analyzing unit that analyzes correlation between a plurality of notifications received by the receiving unit, on the basis of the information collected by the collecting unit.

Systems and methods consistent with the invention may provide another apparatus that comprises: a collecting unit that collects information regarding a packet forwarding path, the path being dynamically established in a network; a receiving unit that receives a notification indicating that an event has occurred on an element of the network; a registering unit that registers information indicating that a maintenance of an element in the network is scheduled and a scheduled start time of the maintenance; and an analyzing unit that analyzes correlation between an execution of the maintenance registered by the registering unit and the event notification received by the receiving unit, on the basis of the information collected by the collecting unit.

Systems and methods consistent with the invention may provide yet another apparatus that comprises: a collecting unit that collects information representing interrelation between elements in a network; a receiving unit that receives a notification indicating occurrence of an event on an element of the network; an analyzing unit that, on the basis of the information collected by the collecting unit, specifies another notification concerning another element to be received in a case of occurrence of the event indicated by the notification received by the receiving unit; and a managing unit that detects whether said another notification specified by the analyzing unit is received by the receiving unit within a predetermined time period.

Systems and methods consistent with the invention may provide a method that comprises: collecting information regarding a packet forwarding path, the path being dynamically established in a network; receiving a plurality of notifications, each notification indicating that an event has occurred on an element of the network; and analyzing correlation between the plurality of notifications received, on the basis of the collected information.

Systems and methods consistent with the invention may provide another method that comprises: collecting information representing interrelation between elements in a network; receiving a notification indicating occurrence of an event on an element of the network; specifying, on the basis of the collected information, another notification concerning another element to be received in a case of occurrence of the event indicated by the received notification; and detecting whether said another notification specified is received within a predetermined time period.

As described hereafter, other aspects of the invention exist. Thus, this summary of the invention is intended to provide a few aspects of the invention and is not intended to limit the scope of the invention described and claimed herein.

### BRIEF DESCRIPTION OF THE DRAWINGS

The accompanying drawings are incorporated in and constitute a part of this specification. The drawings exemplify certain aspects of the invention and, together with the description, serve to explain some principles of the invention.

FIG. 1 shows an exemplary internal configuration of a monitoring apparatus 100 consistent with the principle of the invention;

FIG. 2 shows an example of elements of a network 300 and occurrence of a failure;

FIG. 3 shows an example of logical path information stored in a logical path information memory 140;

FIG. 4 shows an example of event log information stored in an event log memory 150, in which events related to LSPs established by RSVP are handled;

FIG. 5 shows an example of information generated by a user presentation information creating section 170 and displayed on a display screen, in order to present an event occurred on a logical element and its affecting events, which brought about that event, to a user;

FIG. 6 shows an example of information generated by the user presentation information creating section 170 and displayed on the display screen, in order to present an event occurred on a physical element and its affected events, which were brought about by that event, to the user;

FIG. 7 shows another example of elements of a network 300 and occurrence of a failure;

FIGS. 8A and 8B show another example of logical path information stored in the logical path information memory 140, in which FIG. 8A shows a table of LSP routes and FIG. 8B shows a table of VPNs that use logical paths;

FIG. 9 shows another example of event log information stored in the event log memory 150, in which events related to VPNs are handled;

FIG. 10 illustrates a case in which the correlation analysis is performed in response to a reception of an event notification, showing an example of event log information stored in the event log memory 150;

FIG. 11 shows yet another example of elements of a network 300 and occurrence of a failure;

FIGS. 12A and 12B show yet another example of logical path information stored in the logical path information memory 140, in which FIG. 12A shows a table of OSPF topology and FIG. 12B shows a table of VPNs that use logical paths;

FIG. 13 shows yet another example of event log information stored in the event log memory 150, in which events related to IP routes of OSPF are handled;

FIG. 14 shows yet another example of event log information stored in the event log memory 150, in which events related to LSPs established using LDP are handled;

FIG. 15 shows an exemplary internal configuration of a monitoring apparatus 200 having a scheduled maintenance management function consistent with the principle of the invention;

FIG. 16 shows an example of scheduled maintenance information stored in a scheduled maintenance memory 290;

FIG. 17 shows an example of information displayed on a display screen, by which a user can input scheduled maintenance information into the monitoring apparatus 200 through a scheduled maintenance managing section 280;

FIG. 18 shows an example of information generated by a user presentation information creating section 270 and displayed on a display screen, in order to present notified events and their corresponding scheduled maintenances, which caused the notified events, or scheduled maintenances and their corresponding events, which were notified due to the maintenances, to a user;

FIG. 19 shows an example of information generated by the user presentation information creating section 270 and displayed on the display screen, in order to present past events related to scheduled maintenances to a user;

FIG. 20 shows an exemplary internal configuration of a monitoring apparatus 400 having a failure prediction function consistent with the principle of the invention;

FIG. 21 shows yet another example of elements of a network 300 and occurrence of a failure;

FIG. 22A shows an example of information stored in a path information memory 440 (link-port association table) and FIG. 22B shows an example of information stored in a port event managing section 480;

FIG. 23 shows an example of event log information stored in an event log memory 450 in the example of FIGS. 22A and 22B;

FIG. 24 is a flowchart of an exemplary process for predicting a failure in the example of FIGS. 22A and 22B;

FIG. 25A shows another example of information stored in the path information memory 440 (LSP route table) and FIG. 25B shows another example of information stored in the port event managing section 480;

FIG. 26 shows an example of event log information stored in the event log memory 450 in the example of FIGS. 25A and 25B;

FIG. 27 is a flowchart of an exemplary process for predicting a failure in the example of FIGS. 25A and 25B;

FIG. 28 shows an example of event log information stored in the event log memory 450 on the basis of the failure prediction shown in FIG. 27; and

FIG. 29 is a flowchart of an exemplary process for performing selective polling using failure prediction.

### DETAILED DESCRIPTION

The following detailed description refers to the accompanying drawings. Although the description includes exemplary implementations, other implementations are possible and changes may be made to the implementations described without departing from the spirit and scope of the invention. The following detailed description and the accompanying drawings do not limit the invention. Instead, the scope of the invention is defined by the appended claims.

### General Description

According to the techniques disclosed in Japanese Patent Laid-Open No. 7-192188, No. 9-307550, and No. 9-64971, multiple alarms issued due to the same cause can be classified as a group by analyzing the correlation among the alarms received at a monitoring apparatus. However, because these conventional techniques obtain correlation by statistically analyzing a large number of alarms that have been already generated, these techniques, at most, can identify the cause of only failures that occurred in the past and are physically related such as failures in nodes, links, and ports.

To provide more sophisticated monitoring, it is desirable for a network monitoring tool to be configured so that a monitoring apparatus receives, in response to occurrence of one failure, not only alarms concerning physical network elements such as nodes, links, and ports, but also alarms concerning logical paths (packet forwarding paths) that use these physical elements.

Such logical paths that can be monitored include a route along which a label switched path (LSP) is set and/or a route through which packets are transferred according to Internet Protocol (IP), for example. The inventors have proposed a mechanism for monitoring routes of the former type in United States Patent Application Publication No. 2005/0220030 and a mechanism for monitoring routes of the latter type in United States Patent Application Publication No. 2005/0232230, both publications hereby incorporated by reference.

A label switched path is set in a network over which packets are transferred using MPLS (Multi Protocol Label Switching). Routers on the label switched path do not determine a destination of the packets by checking the address of the packets in the network layer, but use labels assigned to the packets in order to make fast switching thereby implementing fast packet transfer. In an MPLS network, messages such as RSVP (Resource reservation Protocol) messages or LDP (Label Distribution Protocol) messages are exchanged between a start (ingress) node and an end (egress) node or between neighboring nodes on a path from its staring point to end point to establish an LSP, which is a logical path (a packet forwarding path) through plural nodes and links.

In the case of an IP network, a packet forwarding path (a logical path) formed by nodes and links through which packets are to be transferred is computed on the basis of routing information obtained by exchanging messages such as OSPF or IS-IS (Intermediate System-to-Intermediate System) messages among many routers placed in the network. OSPF and IS-IS operate within one network operating under a common policy or the same control, which is called AS (Autonomous System). In order to compute a packet forwarding path formed over two or more ASs, routing information obtained by exchanging BGP messages or the like are used.

The conventional techniques described above do not analyze correlation between alarms that include those concerning dynamically changing logical paths, and therefore would present many alarms on logical paths, both correlated alarms and not correlated alarms, indistinguishably to a network administrator, confusing him/her. Similarly, the conventional techniques disclosed in Japanese Patent Laid-Open No. 9-168010 do not inhibit alarms concerning dynamically changing logical paths, and therefore would present all alarms on logical paths, whether caused by scheduled maintenances or not, indistinguishably to the network administrator.

Furthermore, the conventional techniques described above can identify an alarm causing a series of other alarms when the series of alarms are received, but cannot identify a range affected by a causal failure when an alarm of the causal failure is received in a packet network environment such as an IP or MPLS network. For example, the conventional techniques cannot identify a logical path on which a secondary alarm will occur due to one physical failure. In an example where customers or services that use respective logical paths are predetermined, the conventional techniques cannot identify a customer or service ultimately affected by a failure on a logical path.

Methods and systems consistent with the invention may analyze correlation between alarms (event notifications) concerning network elements, including dynamically changing logical paths (packet forwarding paths), and present a result of the analysis to a network administrator.

Methods and systems consistent with the invention may specify events that will secondarily occur on other elements due to a causal event, and identify customers and services that will be affected by the causal event and the secondary events. A network administrator who finds out the affected range is able to take measures accordingly, for example, letting affected customers know the period during which packets were not being transferred for their attention.

A first network monitoring apparatus consistent with the invention comprises: a collecting unit that collects information regarding a packet forwarding path, the path being dynamically established in a network; a receiving unit that receives a notification indicating that an event has occurred on an element of the network; and an analyzing unit that analyzes correlation between a plurality of notifications received by the receiving unit, on the basis of the information collected by the collecting unit.

The types of events indicated in notifications received by the receiving unit may include a failure and a failure recovery on an element. If the element is a packet forwarding path or a logical path such as a label switched path, one of the types of events can possibly be an alteration indicating that a route from the same start point to the end point has been changed. After a failure occurs on a physical element on a route, a logical path may be recovered using the same route as before upon recovery of the failure itself or establishing a different route than before, or a logical path failure may be avoided by altering the route. Furthermore, events such as addition of new elements and removal of existing elements to and from the network can be monitored.

The analyzing unit may use information regarding a packet forwarding path that can be presumed to have been used when the event occurred, on the basis of a time identified by the notification received by the receiving unit, among information regarding the packet forwarding path at a plurality of times collected by the collecting unit. Therefore, correlation between event notifications on elements including dynamically changing packet forwarding paths can be analyzed.

The analyzing unit may analyze the correlation irrespective of an order in which the plurality of notifications were received by the receiving unit. Therefore, proper analysis and monitoring can be performed in a network where packets such as IP packets can be received in an order different from the order in which they have been transmitted.

The collecting unit may collect routing information exchanged between nodes in the network, and the analyzing unit may use the routing information (for example, information acquired from messages exchanged using protocols such as OSPF, IS-IS, or BGP) to calculate a packet forwarding path and may analyze the correlation on the basis of the calculated packet forwarding path.

The collecting section may collect information (for example, information acquired from messages exchanged using RSVP or LDP, which may be information held by nodes that perform label switching) regarding a label switched path established in the network, and the analyzing unit may analyze whether there is correlation between an event concerning a label switched path and an event concerning a link passed through by the label switched path.

The network monitoring apparatus may further comprise a memory that stores information regarding events indicated by notifications received by the receiving unit as a log, wherein the analyzing unit may, in response to a request by a user, analyze correlation between the events regarding which the log information is stored in the memory, and present a result of the analysis to the user. For example, when the user instructs to display events that occurred in a certain range, the log memory may be searched for the events in that range. In this example, when searching the events, correlation between the found events is analyzed.

The network monitoring apparatus may further comprise a memory that stores information regarding an event indicated by a notification received by the receiving unit, wherein the analyzing unit may, in response to a reception by the receiving unit, analyze correlation between the event regarding which the information is stored in the memory and an event indicated by a notification received, and store a result of the analysis in the memory. For example, upon receiving an event, correlation between events received in a predetermined time period may be analyzed and stored in the log memory along with the event information. In this example, the correlation stored can be retrieved and displayed along with the events by referring to the log memory upon request from a user.

In the configuration described above, the analyzing unit may include: a unit that identifies, on the basis of the information regarding the packet forwarding path, a notification indicating occurrence of an event causing a series of correlated events among the plurality of notifications; and a unit that specifies, on the basis of the information regarding the packet forwarding path, an event that secondarily occurs on another element due to occurrence of the causing event.

With this configuration, not only an event that caused a series of event notification can be identified but also the range affected by the causal event can be identified from that causal event. For example, when a causal event occurred on an element, events that will secondarily occur on another element due to the causal event can be specified in advance, and such events can be displayed at a time. In another example, it can be detected that a notification of a secondary event that should occur due to the causal event has not arrived. In yet another example, secondary events caused by a scheduled maintenance can be displayed in such a manner that they can be distinguished from events caused by a genuine failure needing a recovery action.

In the configuration described above, the collecting unit may comprise a unit that collects, in addition to the information regarding the packet forwarding path, information indicating an entity (a customer, a service, or the like) that uses the packet forwarding path, and the analyzing unit may comprise a unit that identifies, on the basis of the information indicating the entity, an entity affected by occurrence of the causing event. Therefore, an entity that uses an element (in this example, a packet forwarding path) on which a secondary event occurs due to occurrence of the causal event can be identified. The user can grasp customers and services that are affected by occurrence of a certain event.

The configuration described above may further comprise a unit that, if the causing event is a failure, estimates a time period during which packets related to said another element on which the secondary event occurs are not transferred, on the basis of a time identified by the notification indicating the occurrence of the causing event.

For example, the starting time of the period of time during which packets are not transferred may be estimated from the notification of occurrence of the causal event, and when a notification indicating a recovery from failure on said another element or a notification of an alteration made for avoiding failure is received, the end time of the period of time during which packets are not transferred may be estimated from such a notification. Thus, the user can identify the time period between the occurrence of the first physical failure and the removal of the secondary failures by recovery or alteration of a packet forwarding path of interest or a service that uses the path, as a time period (a downtime) during which packets are not transferred, and can let an affected customer know the time period.

The configuration described above may further comprise a unit that presents a notification of the secondary event that occurs on said another element to a user in a form that varies depending on the level of severity of the secondary event. With this configuration, a series of secondary events can be classified into plural levels, and critical events such as failures for which a user's certain action is required can be displayed in red whereas other events such as alterations for which a user's attention is enough can be displayed in yellow, for example.

The network monitoring apparatus may further comprise a unit that, if a notification indicating that the secondary event specified by the analyzing unit to occur on said another element has actually occurred is not received by the receiving unit, presents an abnormal condition to a user. Thus, if a failure has occurred on a network element itself that should send the secondary event notification to the monitoring apparatus, or the notification of the secondary event sent has been lost on the way and has not been received at the monitoring apparatus, for example, such situations can be detected, as the monitoring apparatus examines whether the potential notification of the secondary event is actually received. This means that even if a notification (alarm) about a failure is not actually received, the occurrence of the failure can be predicted by the monitoring apparatus.

The network monitoring apparatus may further comprise a unit that, if a notification indicating that the secondary event specified by the analyzing unit to occur on said another element has actually occurred is not received by the receiving unit, checks a status of said another element. With this configuration, whether a failure has occurred on a network element itself that should send the secondary event notification to the monitoring apparatus or the notification of the secondary event sent has been lost on the way can be distinguished from each other.

As the frequency of periodic polling in the conventional techniques to a large number of network elements for checking their status is increased, the load on the network increases. In contrast, with the above-described configuration, selectively polling can be implemented by polling when an event notification predicted on the monitoring apparatus is not received. With this selective polling, the status of network elements can be properly checked with a reduced load on the network.

A second network monitoring apparatus consistent with the invention comprises: a collecting unit that collects information regarding a packet forwarding path, the path being dynamically established in a network; a receiving unit that receives a notification indicating that an event has occurred on an element of the network; a registering unit that registers information indicating that a maintenance of an element in the network is scheduled and a scheduled start time of the maintenance; and an analyzing unit that analyzes correlation between an execution of the maintenance registered by the registering unit and the event notification received by the receiving unit, on the basis of the information collected by the collecting unit.

With this configuration, whether events on dynamically changing packet forwarding paths have been caused by a scheduled maintenance or by a genuine failure can be distinguished from each other.

The analyzing unit may comprise a unit that, in response to a reception by the receiving unit, determines whether the execution of the maintenance causes the event indicated by the notification, on the basis of information regarding the packet forwarding path at a time identified from the reception. For example, upon reception of an event notification, the log memory may be searched for a causal event of the notified event and the registered information may be referred to in order to determine whether the causal event is a scheduled maintenance.

The analyzing unit may comprise: a unit that, in response to a start of the maintenance, specifies an event that secondarily occurs on another element due to the execution of the maintenance, on the basis of information regarding the packet forwarding path at a time identified from the start, and stores the specified event; and a unit that, in response to a reception by the receiving unit, determines whether the event indicated by the notification is stored as the specified event. For example, when the maintenance is started, a series of events that will be caused by the maintenance may be specified to be stored and, when subsequently an event notification is received, the stored events may be referred to in order to determine whether the notified event is one of the series of events caused by a scheduled maintenance.

A third network monitoring apparatus consistent with the invention comprises: a collecting unit that collects information representing interrelation between elements in a network; a receiving unit that receives a notification indicating occurrence of an event on an element of the network; an analyzing unit that, on the basis of the information collected by the collecting unit, specifies another notification concerning another element to be received in a case of occurrence of the event indicated by the notification received by the receiving unit; and a managing unit that detects whether said another notification specified by the analyzing unit is received by the receiving unit within a predetermined time period.

With this configuration, based on a received notification of an event, occurrence of other events related to the notified event can be predicted at the monitoring apparatus. If a notification of a predicted event (a potential notification) is not received, it can be detected as a possible abnormal condition.

The information collected by the collecting unit may be at least one of information regarding a set of elements directly interconnected in the network and information regarding a packet forwarding path dynamically established in the network.

In the case where the information regarding a set of elements directly interconnected is collected, if a failure occurs on one link, for example, each of the nodes at both ends of the link will report a failure event on the ports connected to the link, to the monitoring apparatus. Therefore, if a failure notification is received from one of the nodes but not from the other, it can be detected that the notification could have been lost on the way or the other node is possibly not properly operating.

In the case where the information regarding a packet forwarding path dynamically established is collected, if a failure occurs on one link, for example, not only the failure event on the link but also a failure event on a label switched path (or paths) passing through the link will be reported to the monitoring apparatus. Therefore, if a notification on the label switched path is not received, it can be detected that the notification could have been lost on the way or the node that should send the notification is possibly not properly operating.

In the configuration described above, if the management unit detects that said another notification has not been received within the predetermined time period, an abnormal condition may be presented to a user. The user can then check the operation of a node that should send said another notification and, if needed, can repair the node.

The configuration described above may further comprise a checking unit that sends a message for checking a status of said another element onto the network, if the managing unit detects that said another notification has not been received within the predetermined time period. With this configuration, it can be checked whether said another notification has been lost on the way or has not been sent by the node due to its improper operating. If an abnormality is detected on the basis of a reply to the message sent by the checking unit, the user may be notified of the abnormality. Compared to the example of presenting an abnormal condition to the user each time a potential notification has not been actually received, this configuration can reduce the number of abnormal notifications presented to the user by thus focusing on actually required ones.

With the above-described the checking unit, compared to periodically polling (sending a check message to and receiving a reply from) all of a large number of elements of the network, the status of network elements can be properly checked with a reduced load on the network by polling selected elements on which a problem has possibly occurred.

A first network monitoring method consistent with the invention comprises: collecting information regarding a packet forwarding path, the path being dynamically established in a network; receiving a plurality of notifications, each notification indicating that an event has occurred on an element of the network; and analyzing correlation between the plurality of notifications received, on the basis of the collected information.

The first network monitoring method may further comprise registering information indicating that a maintenance of an element in the network is scheduled and a scheduled start time of the maintenance. In addition, during the analysis described above may analyze correlation between a first notification indicating that an event corresponding to the scheduled maintenance registered using the fourth program code has occurred and a second notification indicating that another event has occurred.

A second network monitoring method consistent with the invention comprises: collecting information representing interrelation between elements in a network; receiving a notification indicating occurrence of an event on an element of the network; specifying, on the basis of the collected information, another notification concerning another element to be received in a case of occurrence of the event indicated by the received notification; and detecting whether said another notification specified is received within a predetermined time period.

The second network monitoring method may further comprise sending a message for checking a status of said another element onto the network, if it is detected by the fourth program code that said another notification has not been received within the predetermined time period.

It will be understood that methods and systems consistent with the invention can also be implemented as a program for causing a computer to function as the network monitoring apparatus described above, a program for causing a computer to perform the network monitoring method described above, or a recording medium on which such a program is recorded.

As described above, according to one aspect of methods and systems consistent with the invention, plural events having the same cause, including those occurring on dynamically changing packet forwarding paths, can be related together. Also, an arrangement can be added for determining whether the cause is a scheduled maintenance or an unexpected failure.

According to another aspect of methods and systems consistent with the invention, occurrence of an event on another event that has reported can be predicted and a case where a notification of the event is not received can be detected, whereby a possible abnormality can be noticed in advance and/or network load placed by polling can be reduced.

A combination of the above-described two aspects can also be implemented consistently with the invention.

### Description with Reference to Drawings

Exemplary embodiments of the above-described configuration will be described below with reference to the drawings.

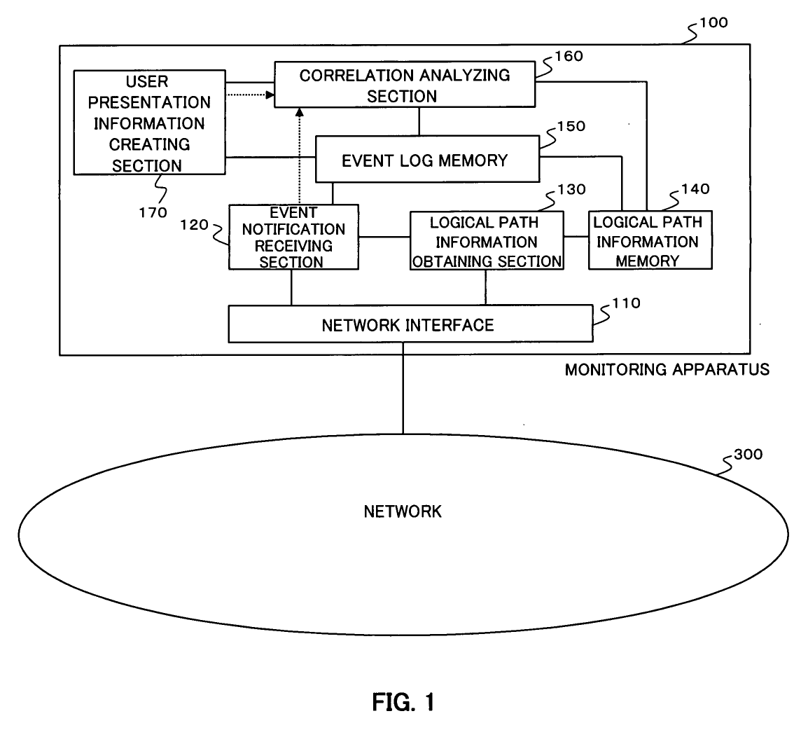

FIG. 1 shows an exemplary internal configuration of a monitoring apparatus 100 consistent with the invention. The monitoring apparatus 100 is connected to a network 300 to be monitored. While an example in which one monitoring apparatus is provided for one network will be illustrated herein, a large-scale network to be monitored may be divided into areas and each of a plurality of monitoring apparatuses may monitor an assigned area. A central monitoring apparatus may be further provided that collects information from monitoring apparatuses monitoring assigned areas and monitors the entire network.

A user interface (e.g., a display screen or a command input device used by a network administrator) of the monitoring apparatus 100 may be built in the monitoring apparatus 100 or may be provided as a separate device. In the latter case, the single monitoring apparatus 100 can be configured in such a manner that the apparatus can be used from a plurality of user interface devices (e.g., remote consoles or computers that can access the monitoring apparatus 100 over the network 300).

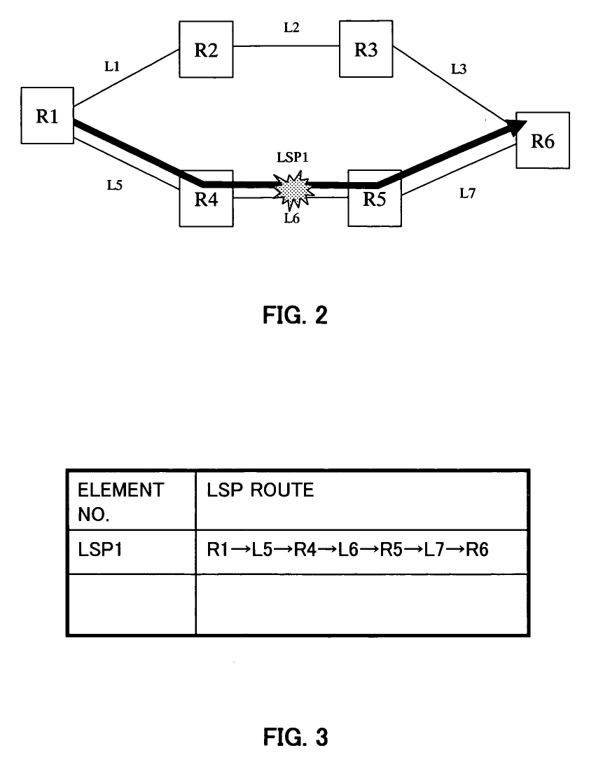

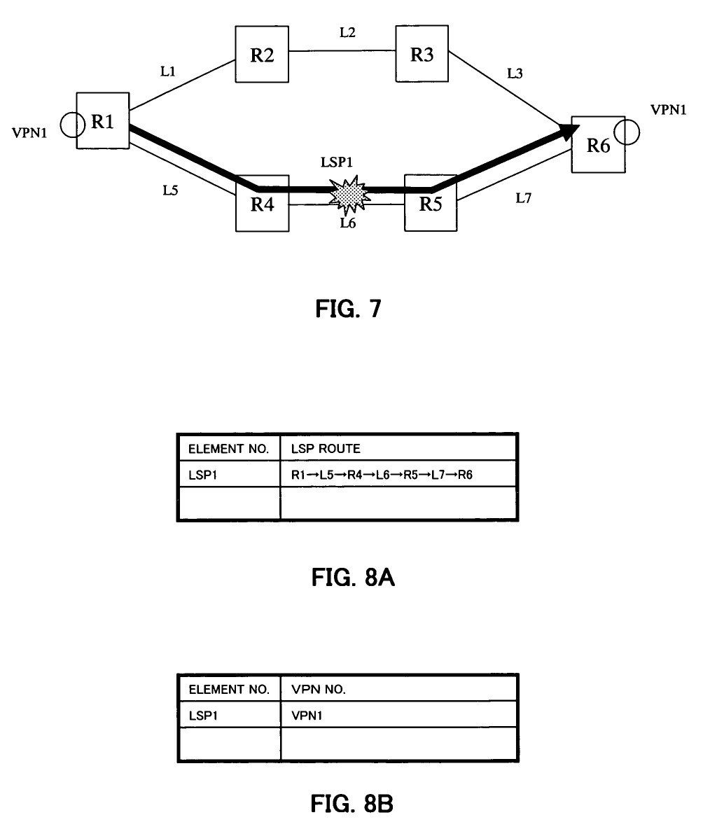

As illustrated in FIGS. 2, 7, 11, and 21, the network 300 includes many elements such as nodes (denoted by “R” in the figures), links (denoted by “L” in the figures) that interconnect neighboring nodes, label switched paths (hereinafter referred to as the “LSP”) that provide fast packet transfer between non-neighboring nodes through one or more nodes by interconnecting links through label switching. The use of an LSP may be limited to particular customers or services so that they can exclusively use the LSP. In the example in FIG. 7, the LSP is dedicated to VPN (Virtual Private Network) 1 connected to both ends of the LSP.

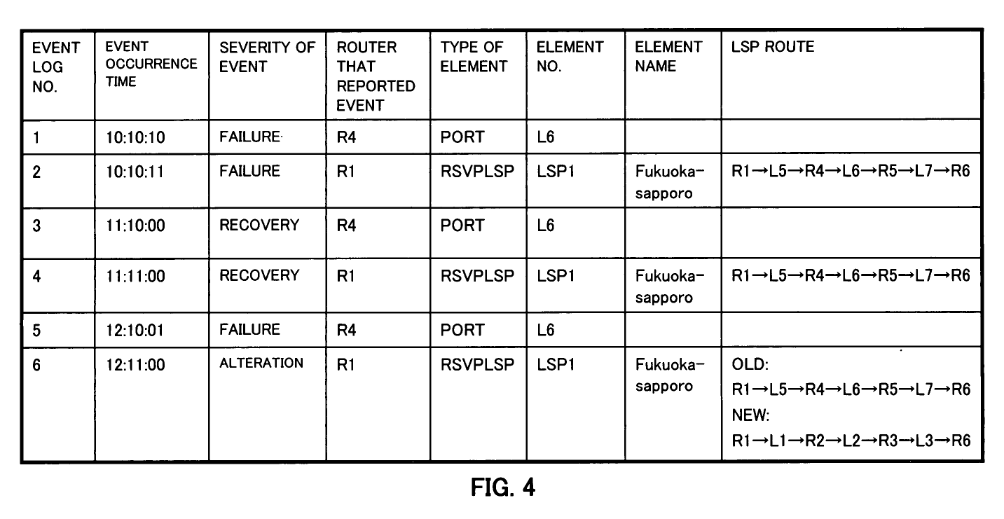

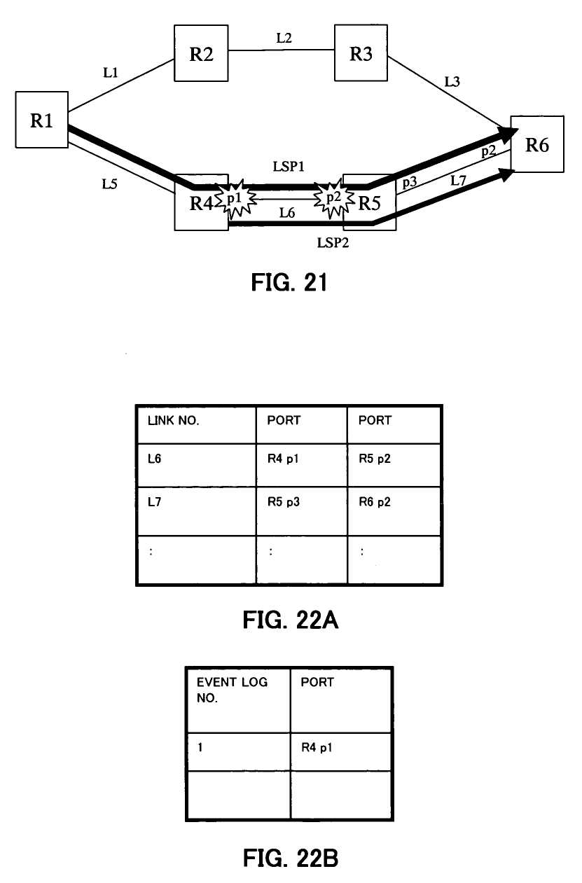

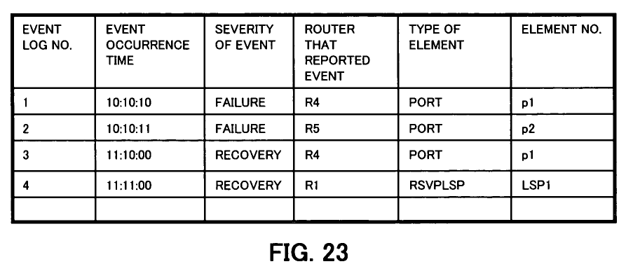

Since a node typically has plural ports (denoted by “p” in the figures), a link connects a port of one node to a port of another node as shown in FIG. 21 in particular. Accordingly, a link can be identified in the form of a link (L) extending from a node (R) (as in the examples shown in FIGS. 4, 9, 10, 13, and 14) or in the form of a port (p) of a node (R) connecting to the link (as in the examples in FIGS. 23 and 26).

The monitoring apparatus 100 includes a network interface 110 for connecting to the network 300, an event notification receiving section 120 which receives event notifications from the network, and a logical path information obtaining section 130 which collects logical path information from the network 300. Information about the route of LSP and/or information about OSPF or IS-IS used for computing IP packet forwarding paths may be the logical path information. The logical path information obtaining section 130 may also collect information about entities that use logical paths.

The logical path information obtaining section 130 stores collected logical path information in a logical path information memory 140. Logical path information may be collected by periodically sending inquiries to the nodes on the network 300 and receiving information returned from the nodes and/or may be collected by receiving information sent from nodes on the network 300 when alterations are made. Alternatively or additionally, when the event notification receiving section 120 has received an event notification indicating the possibility that the route of a logical path was changed, the logical path information obtaining section 130 may obtain new logical path information by sending a inquiry to the node that sent the event notification or to a related node.

Information about an event reported by a notification received by the event notification receiving section 120 is stored in an event log memory 150. If an event about a logical path is to be stored, route information about the logical path may be read from the logical path information memory 140 and stored in the event log memory 150. Types of events stored in the event log memory 150 include failure, recovery, and alteration, in this example. Among the events stored in the event log memory 150, an event representing a failure that has not been recovered after the failure occurred on an element in the network is sometimes referred to as “active” event.

A correlation analyzing section 160 analyzes the correlation between events stored in the event log information memory 150 in response to an instruction from a user presentation information creating section 170 or when the correlation analyzing section 160 is notified of reception of an event by the event notification receiving section 120. If an event related to a logical path is to be analyzed, information about the entity that uses the logical path may be read from the logical path information memory 140 and used for analysis.

The user presentation information creating section 170 accepts a command from a user interface, not shown, generates information, and outputs the information to a display screen to allow it to display the information. The user presentation information creating section 170 can present correlation between events obtained by the correlation analyzing section 160 to a user, in addition to information about an event read from the event log memory 150 and the position or route in network topology of the element on which the event occurred. When presenting event information to a user, the user presentation information creating section 170 reads the events to be presented from the event log memory 150. When presenting correlation, the user presentation information creating section 170 instructs the correlation analyzing section 160 to obtain event information related to a specified event.

The monitoring apparatus 100 is typically implemented by installing a software program for implementing the functions of the components described above in a computer having a sufficient memory capacity and the capability of executing the program. However, some of the functions described above may be implemented by dedicated hardware. Memories in the monitoring apparatus can be any devices for storing data, including semi-conductor memories, hard disks, CDs, DVDs, and so on.

The route of a logical path on the network 300 is dynamically changed. Each time a route is changed, the monitoring apparatus 100 obtains and stores the route. Accordingly, the monitoring apparatus 100 can analyze correlation concerning the logical path whose route is dynamically changed. Thus, the correlation between events on an MPLS or IP network can be properly analyzed.

Specific operation of the correlation analyzing section 160 will be described with respect to several examples. First, an example will be described with reference to FIGS. 2 to 4 in which correlation analysis is triggered by an instruction from the user presentation information creating section 170 to search the event log memory 150 and is performed on a link (port) and an LSP established using RSVP, which are elements of the network 300.

A case where a failure has occurred on a link L6 that connects router R4 with router R5 will be considered here as shown in FIG. 2. Because LSP 1 has been established along the route from R1 to R4 to R5 to R6, L6 is used by LSP 1. When a causal failure occurs, router R4 sends a notification of the occurrence of the failure on the L6 to the monitoring apparatus 100 by an SNMP trap. The information is received by the event notification receiving section 120 and is stored in the event log memory 150 as event log number 1 (see FIG. 4).

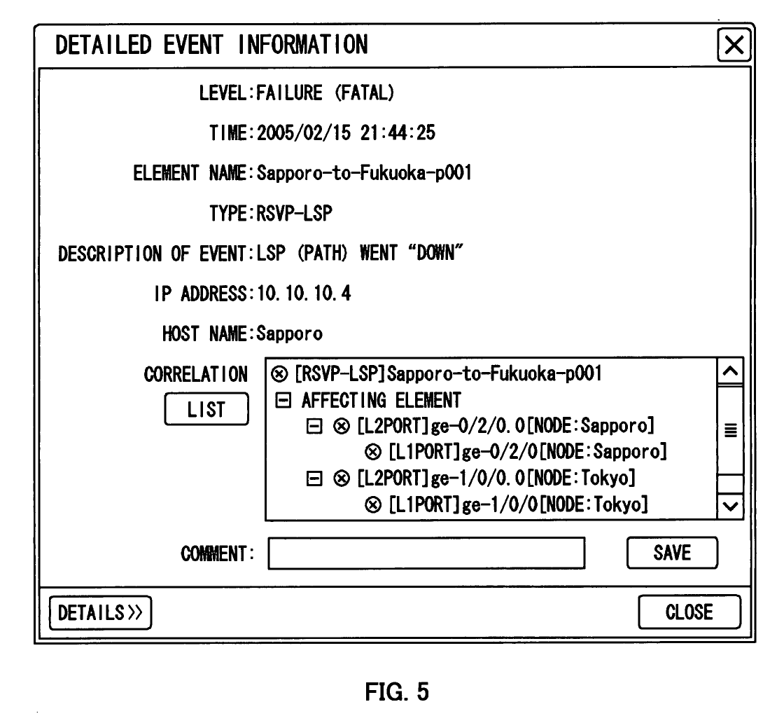

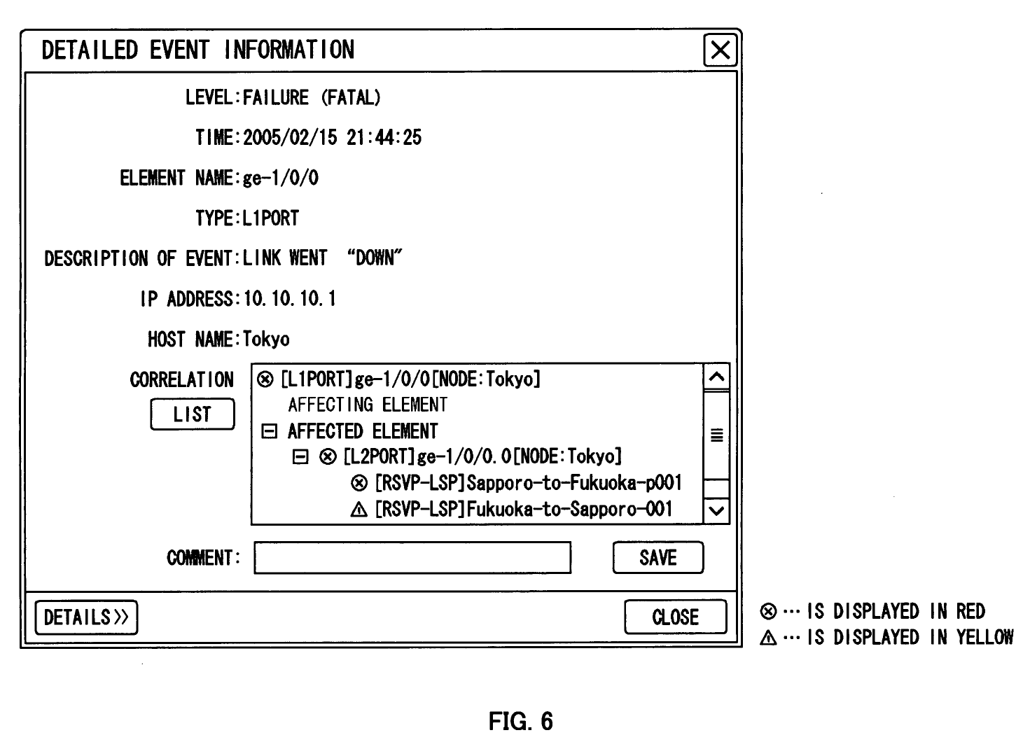

In practice, a failure (and recovery) on L6 is notified from the nodes at both ends of the link as shown in FIGS. 5 and 6. Therefore, node R4 reports an event at port p1 and node R5 reports an event at port p2. The monitoring apparatus 100 can interpret the two event notifications as indication of one event on the same link because a link-port association table as shown in FIG. 22A is stored in the monitoring apparatus 100 as information about network topologies. The events on the same link are stored as one event (the event on one of the nodes at both ends, R4, as the representative) in the example shown in FIG. 4, but the two events received may simply be stored in another example.

Stored in the event log information memory 150 in FIG. 4 are a “Router that reported event”, which is a source node of an event notification received; a “Severity of event”, which is the type of event (failure, recovery, or alteration); a “Type of element”, which is the type of an element (link (port) or LSP) on which the event occurred; and an “Element number”, which is an identifier for identifying the element. Here, an element is uniquely identified within the network 300 (in the monitoring apparatus 100) by the combination of a “Router that reported event” and an “Element number”. In the case of an LSP established using RSVP, the “Router that reported event” may be the router at the start point of the LSP and the “Element number” may be an LSP identifier specified as a tunnel ID. For an LSP, the LSP name (a name such as “Tokyo-Osaka” given by an ISP administrator for convenience) and a route (the routers that exist on the route from start point via relay point or points to end point, and the links between the routers) are also stored.

Also stored in the event log information memory 150 in FIG. 4 is an “Event occurrence time,” which is identified based on a notification received. For example, the current time at which a notification was received at the monitoring apparatus 100 may be stored as the event occurrence time. Alternatively, if time synchronization among routers is maintained, event occurrence time may be written in notifications sent by routers and the monitoring apparatus 100 may read and store the event occurrence time. Time written by each router may be the current time at which a notification was sent, or may be the current time at which an event was detected. Furthermore, the monitoring apparatus 100 may set, for each router that sends an event notification, which of the time of reception of an event notification and the time written in an event notification is to be stored as the event occurrence time.

When R1, which is the router at the start point of LSP 1 using L6 on which the failure occurred, detects the occurrence of the failure on LSP 1, the router R1 sends a notification of the occurrence of the failure to the monitoring apparatus 100 by an SNMP trap. This notification is received by the event notification receiving section 120 and stored as a record with event log number 2 in the event log memory 150 (see FIG. 4). The monitoring apparatus 100 has collected route information about LSP 1 and stored it in the logical path information memory 140 in advance as shown in FIG. 3. Route information about an LSP may be collected via the method proposed by the inventors in United States Patent Application Publication No. 2005/0220030.

When storing an event on LSP 1 associated with event log number 2 as described above, the event log memory 150 reads the route of LSP 1 from the logical path information memory 140 and stores it along with the event (see FIG. 4). If the type of the reported event is recovery or alteration of an RSVP-LSP, the logical path information obtaining section 130 can ask router R1 for route information to newly obtain it because router R1 has effective route information about LSP 1. If the type of the reported event is failure, the monitoring apparatus 100 uses route information about LSP stored in advance in the logical path information memory 140 to store it into the event log memory 150 because router R1 does not have effective route information about LSP 1.

If the user presentation information creating section 170 instructs the correlation analyzing section 160 by specifying the event associated with log number 2 to find an event that caused the specified event, the correlation analyzing section 160 checks events that have occurred in a predetermined period of time before and after the specified event to see whether a failure has occurred in a link or router on an LSP route recorded in the specified event so as to derive the causal event because the event associated with log number 2 is an event on the LSP. In the event log in FIG. 4, it is found that the event associated with log number 1 is a failure on L6 included in the route of LSP 1. That is, it is found that a port failure associated with event log number 1 is the event that caused the LSP failure associated with event log number 2.

In this example, the found event, which is the port failure with event log number 1, is identified as a root cause. However, if another event that caused the found event can be further traced, the process for deriving the causal event is continued until an event beyond which no further tracing is possible is found. The last found event is identified as the root cause that caused a series of events. All events found until the causal event is finally reached may be called “affecting” events. Therefore, in some examples, the causal event is the affecting event, and in other examples, the causal event is one of the affecting events. Events that secondarily occur due to a certain event may be called “affected” events.

In the above example, one event causes a series of events. However, if plural links on one LSP route fail concurrently, plural events may be found to be causal for one event.

If the user presentation information creating section 170 instructs the correlation analyzing section 160 by specifying the event associated with log number 1 to find secondary events that were caused by the specified event, the correlation analyzing section 160 checks events that have occurred in a predetermined period of time before and after the event to see whether a failure has occurred in a logical path such as an LSP that includes the link in its route to derive the secondary events because the event associated with log number 1 is an event on the link. In the event log in FIG. 4, the event with log number 2 is detected as a failure on LSP 1 whose route includes L6.

In this example, one logical path such as an LSP uses a failed link. However, a plurality of logical paths may use a failed link, and thus a plurality of secondary events may be found, in another example. In yet another example, beyond a first secondary event caused by a causal event, a further secondary event (or events) caused by the first secondary event can possibly be traced. The range affected by a certain causal event can be determined by finding all secondary events as exemplified above.

Whereas the type of event is failure in the example described above, correlation with recovery or alteration events can be similarly analyzed. Specifically, after the failure on L6 is recovered, router R4 reports the recovery to the monitoring apparatus 100 (where the recovery event is then stored as event log number 3 in FIG. 4). After the failure on LSP 1 is recovered, router R1 reports the recovery to the monitoring apparatus 100 (where the recovery event is then stored as event log number 4 in FIG. 4). The correlation analyzing section 160 can find that the recovery event on L6 and the recovery event on LSP 1 are in a cause-and-effect relation.

If a recovery event on an RSVP-LSP is received, route information at that time is obtained from the router at the start point of the LSP and stored in the logical path information memory 140 and the event log memory 150 for use in correlation analysis (see the entry with event log number 4 in FIG. 4). The old route information in the logical path information memory 140 is overwritten with the new route information. In contrast, in the event log memory 150, the new route information is stored in association with the recovery event, with the old route information stored along with the failure event being retained, and therefore for each event, the route information at the time of occurrence of the event remains stored in the memory.

In this example, when the failure on L6, which is the cause of the series of failures, is recovered, the failure on LSP 1 is recovered without changing its route. However, a route used after a recovery of a failure on LSP 1 can differ from a route that was being used when the failure occurred on LSP 1.

An alteration event may be reported if a new route for failure recovery is established without notification of occurrence of a failure on LSP 1 after a failure occurred on L6. Specifically, when a failure on L6 is detected, router R4 reports the failure to the monitoring apparatus 100 (where it is stored as event log number 5 in FIG. 4). When router R1 detects that a different route of LSP 1 is established in order to recover the failure on L6, router R1 may report it to the monitoring apparatus 100 (where it is stored as event log number 6 in FIG. 4).

For an alteration event on an LSP, the correlation analyzing section 160 can check events that occurred within a predetermined time period before and after that event to see whether a failure event has occurred on a link or a router on the old route of the LSP, or whether a recovery event has occurred on a link or route on the new route of the LSP, thereby deriving a causal event. For a failure event on a link, the correlation analyzing section 160 can check events within a predetermined period before and after that event to see whether a failure or alteration event has occurred on an LSP that includes the link on its route, thereby deriving a secondary event.

If an RSVP-LSP alteration event is received, information about the old route of the LSP is read out of the logical path memory 140, and the current route information about the LSP is obtained from the router at the start point of the LSP as the new route. These items of route information are both written in the event log memory 150 and for use in correlation analysis (see the entry with event log number 6 in FIG. 4). The new route information obtained is also written in the logical path information memory 140. Whereas the old route information in the logical path information memory 140 is overwritten with the current (new) route information, information about the old and new routes is stored in the event log memory 150 in association with the alteration event. Thus, for each event, route information at the occurrence of the event is stored in the event log memory 150.

In the example shown in FIG. 4, event notifications are received and stored in the order in which they actually occurred. However, the sequence of reception will sometimes change in the network 300 over which event notifications are transferred. For example, it will happen because a node that first detected occurrence of an event (a causal event) is topologically further away from the monitoring apparatus 100 than a node that later detected occurrence of an event (a secondary event). Consequently, a notification of the causal event is received later than a notification of the secondary event. Also, even if the same node has reported a causal event and a secondary event, the secondary event can arrive at the monitoring apparatus 100 earlier than the causal event when a network 300 is an IP network where the order in which packets are transmitted can change during packet transfer.

Therefore, both when searching for a causal event that caused a specified event and when searching for a secondary event that was caused by a specified event, the correlation analyzing section 160 searches for events that occurred in a predetermined period of time before and after the specified event as described above. In this manner, correlation is analyzed appropriately irrespective of the receiving order.

FIG. 5 shows an example of information generated by the user presentation information creating section 170 and displayed on a display screen in order to present an event that has occurred on a specified logical element (“RSVP-LSP” in the example shown) with its affecting event (or events) to a user. Since the event specified in this example is a failure, the descriptions “Level: Failure (Fatal)” and “Description of event: LSP (Path) went DOWN” may be displayed in red or otherwise highlighted so as to ensure the user's awareness. Other information about the events can also be displayed such as an event occurrence time and a name of the element on which the event occurred.

When “Affecting element” is clicked in the “Correlation” field and the “List” button is pushed in the display screen in FIG. 5, a failure event on a link that the RSVP-LSP passes through is displayed as an event responsible for the above RSVP-LSP failure. Since ports are displayed in this example, events on the ports (L2PORT of Sapporo and L2PORT of Tokyo) at both end of the link on which the failure has occurred are listed as affecting events. The circle with a white “x” in FIG. 5 indicating “failure” is displayed in red to show a fatal level. If another event responsible for the above-identified affecting events exists as a causal event, the causal event may also be displayed in the “Correlation” field.

FIG. 6 shows an example of information generated by the user presentation information creating section 170 and displayed on the display screen in order to present an event that has occurred on a specified physical element (a “link” in the example shown) with its affected event (or events) to a user. Since the event specified in this example is a failure, the descriptions “Level: Failure (Fatal)” and “Description of event: Link went DOWN” may be displayed in red or otherwise highlighted to ensure the user's awareness. Other information about the events can also be displayed such as an event occurrence time and a name of the element on which the event occurred.

When “Affected element” is clicked in the “Correlation” field and the “List” button is pushed in the display screen shown in FIG. 6, failure/alteration events of LSPs that use the link are displayed as affected events caused by the above link failure. In this example, among RSVP-LSPs that use link L1, a failure has occurred on the Sapporo-to-Fukuoka-p001 path, and a route alteration has occurred on the Fukuoka-to-Sapporo-001 path. The circle with “x” in FIG. 6 indicating “failure” is displayed in red to show a fatal level, whereas the triangle with an exclamation mark in FIG. 6 indicating “alteration” is displayed in yellow to show a mere alert level. This display allows the user to distinguish events needing to be urgently addressed from the other events, among a series of events that have secondarily occurred due to the same cause.

Alternatively or additionally, the event information as shown in FIGS. 5 and 6 can be displayed in the form of a network topology map as shown in FIG. 2.

In the example shown in FIGS. 5 and 6, all of a series of events stored in the event log memory that are correlated with one specified event are displayed without distinguishing between active events (failures that have not yet been recovered) and resolved events (events the recoveries of which have been reported after occurrence of the failures). However, the events can also be displayed in various other ways as explained below.

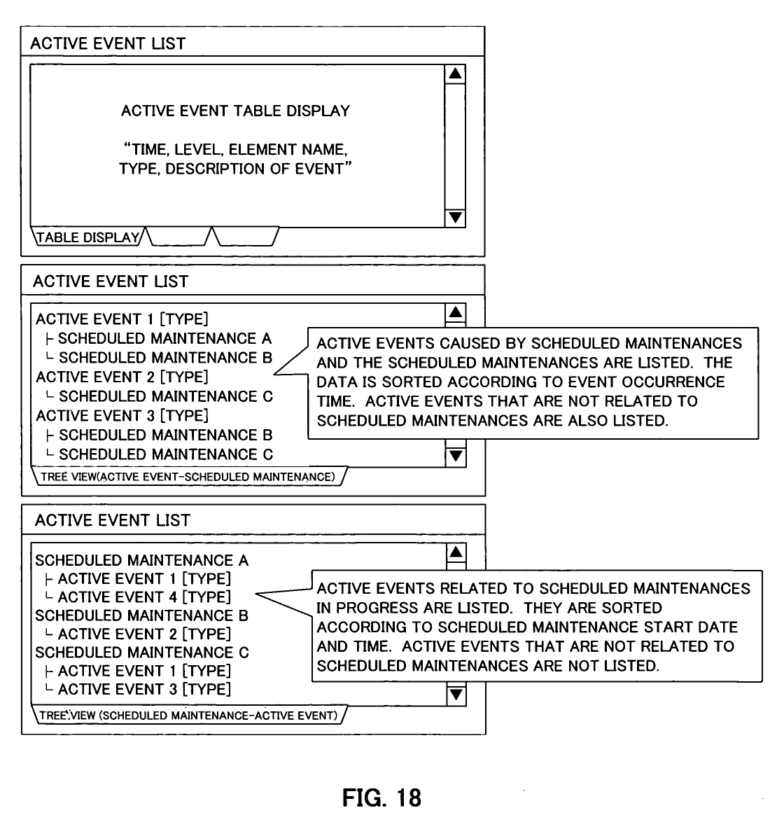

For example, active events may be extracted from the events stored in the event log memory and displayed as an active event list. Further, causal events that caused the listed active events and/or secondary events that were caused by the listed active events may be displayed. A display screen in this example may be similar to that shown in FIG. 18, in which the “scheduled maintenances” are to be replaced with “causal events”.

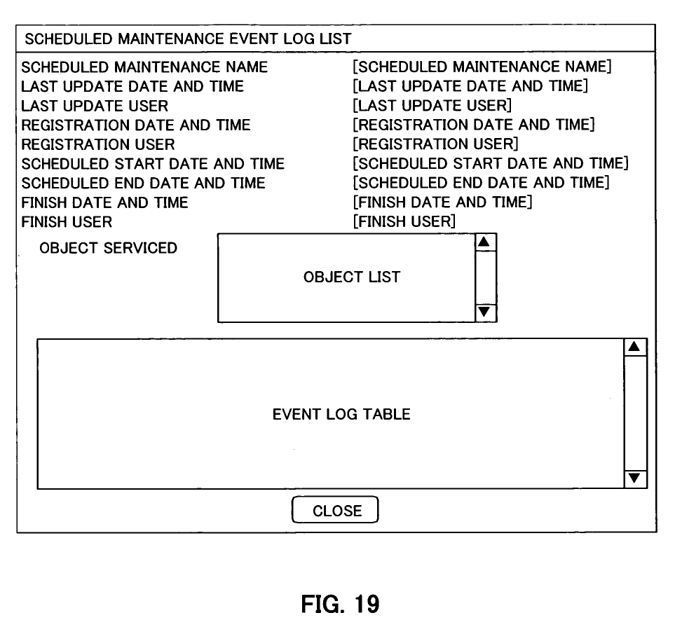

In another example, a resolved causal event may be extracted from the events stored in the event log memory and a list of events caused by the extracted event may be displayed, thereby allowing the user to investigate how a series of events were caused by the causal event and how they were resolved. A display screen in this example may be similar to that shown in FIG. 19, in which the “scheduled maintenance” is to be replaced with the “causal event”. On the other hand, resolved secondary events in a certain range may be extracted from the events stored in the event log memory and listed so that a causal event that caused the event specified on the list can be displayed.

To extract active events from the events stored in the event log memory, the event log may be checked to see whether a recovery event on a certain element exists in associated with a failure event on the same element. If such a recovery event is not found, the failure event can be considered as an active event. Specifically, the extraction can be performed in either of the following two ways. One way is to extract active events from the events stored in the event log memory at once in response to a request from a user for displaying the active event list. The other is to perform extraction each time an event is received as follows. When a failure event is received, the event is stored in an event log with a mark as an active event. When a recovery event is received, a failure event on the same element that is associated with the recovery event is searched for in the event log and the active event mark is removed from the found failure event.

Referring to FIGS. 7 to 9, as components of the network 300, an example will be described in which the correlation analyzing section 160 performs correlation analysis on a link (port) and an LSP established using RSVP and used by a VPN existing as an entity using LSP, in response to an instruction received from the user presentation information creating section 170 to search the event log memory 150.

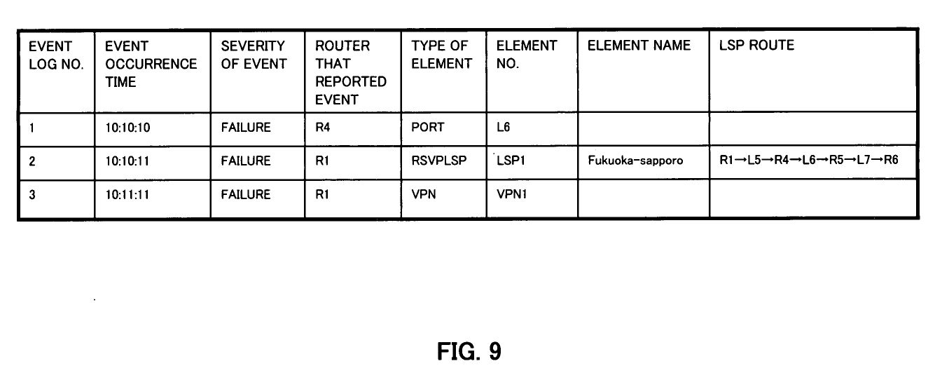

A case where a failure has occurred on link L6 that interconnects routers R4 and R5 will be considered here as shown in FIG. 7. Since LSP 1 is established along the route from R1 to R4 to R5 to R6, link L6 is used by LSP 1. If a causal failure occurs, router R4 sends an SNMP trap indicating the occurrence of the failure on L6 to the monitoring apparatus 100. This is received by the event notification receiving section 120 and stored in the event log memory 150 as event log number 1 (see FIG. 9).

R1, which is the router at the start point of LSP 1, sends an SNMP trap indicating that a failure has occurred on LSP 1 to the monitoring apparatus 100. This also is received by the event notification receiving section 120 and stored in the event log memory 150 in a record with as event log number 2 (see FIG. 9). The monitoring apparatus 100 has collected route information about LSP 1 and stored it in the logical path information memory 140 in advance as shown in FIG. 8A. When storing the event with log number 2 on LSP 1, the event log memory 150 reads the route of LSP 1 from the logical path information memory 140 and stores it along with the information (see FIG. 9).

Since the start-point router of an LSP (the ingress node of an LSP) has the capability of controlling which packets should be transferred onto an LSP established (packets belonging VPN 1 are transferred onto LSP 1 in the example of FIG. 7), association as shown in FIG. 8B is stored in the start-point router. The monitoring apparatus 100 also has obtained the information about the association held by the start-point router R1 of LSP 1 through the logical path information obtaining section 130 and stored it in advance in the logical path information memory 140 as information indicating the VPN that uses the logical path.

If the user presentation information creating section 170 instructs the correlation analyzing section 160 by specifying the event associated with log number 1 in FIG. 9 to search for secondary events caused by the specified event, the event with log number 2 is found similarly to the case shown in FIGS. 2 to 4. In this example, a further secondary event caused by the event with log number 2 is traced back. Specifically, the correlation analyzing section 160 refers to the information indicating the VPN that uses the logical path shown in FIG. 8B stored in the logical path information memory 140, thereby identifying the VPN using LSP 1 on which the event with log number 2 has occurred as VPN 1. The correlation analyzing section 160 then determines whether an event on VPN 1 has occurred in a predetermined period of time before and after the event with log number 2.

Notification by the start-point router R1 of a failure on VPN 1 is stored in the event log in FIG. 9 as an event with log number 3. By tracing events caused by a certain event in sequence in this way, all events caused by the certain event can be identified.

In the example described above, routers have the function of reporting an event on a VPN. In another example, the monitoring apparatus 100 can identify the affected VPN from a reported event on the LSP because the monitoring apparatus 100 has obtained information indicating the VPN that uses the logical path even if routers do not have this capability. Therefore, the monitoring apparatus 100 can indicate to the user the VPN affected by the event on the LSP even if the event on the VPN is not reported. The monitoring apparatus 100 may refer to the logical path information memory 140 in response to the notification of an event on an LSP to identify a VPN that uses the LSP and may write it in the event log memory 150 in FIG. 9 as an event on the VPN. That is, the event with log number 3 in FIG. 9 can be stored by creating a new entry according to determination by the correlation analyzing section 160 even without receiving notification from the start-point router.

If the user presentation information creating section 170 instructs the correlation analyzing section 160 by specifying the event indicated by log number 3 in FIG. 9 to search for an affecting event that caused the specified event, the correlation analyzing section 160 reversely refers to the information indicating which VPN uses which logical path as shown in FIG. 8B stored in the logical path information memory 140, thereby identifying that the LSP used by VPN 1 on which the event with log number 3 has occurred is LSP 1. The correlation analyzing section 160 then checks whether an event on LSP 1 occurred in a predetermined period of time before and after the event with log number 3 to find the event with log number 2. A further affecting event that caused the event with log number 2 is searched for and the event with log number 1 is detected as a causing event, similarly to the example shown in FIGS. 2 to 4.

With respect to the example shown in FIG. 9, only failure events have been described for simplicity, but recovery events may be stored as event logs as in the example in FIG. 4. An example will be described below in which the customer of LSP 1 is VPN1 as shown in FIGS. 7 to 9 and the customer is notified of a service downtime, when event logs in FIG. 4 are obtained.

If a failure has occurred on LSP 1 due to a failure on L6, or a route alteration of LSP 1 has occurred due to a failure on L6, packets transferred from VPN 1 onto LSP 1 may have been lost before reaching the destination. In the former case, the time period between the occurrence time of the causal failure on L6 (event log number 1 in FIG. 4) and the time at which LSP 1 was recovered (event log number 4 in FIG. 4) is notified to the customer, VPN 1, as the time period (downtime) during which packet may have been lost. In the latter case, the time period between the occurrence time of the causal failure on L6 (event log number 5 in FIG. 4) and the time at which the route of LSP 1 was altered (event log number 6 in FIG. 4) is notified to VPN 1 as downtime.

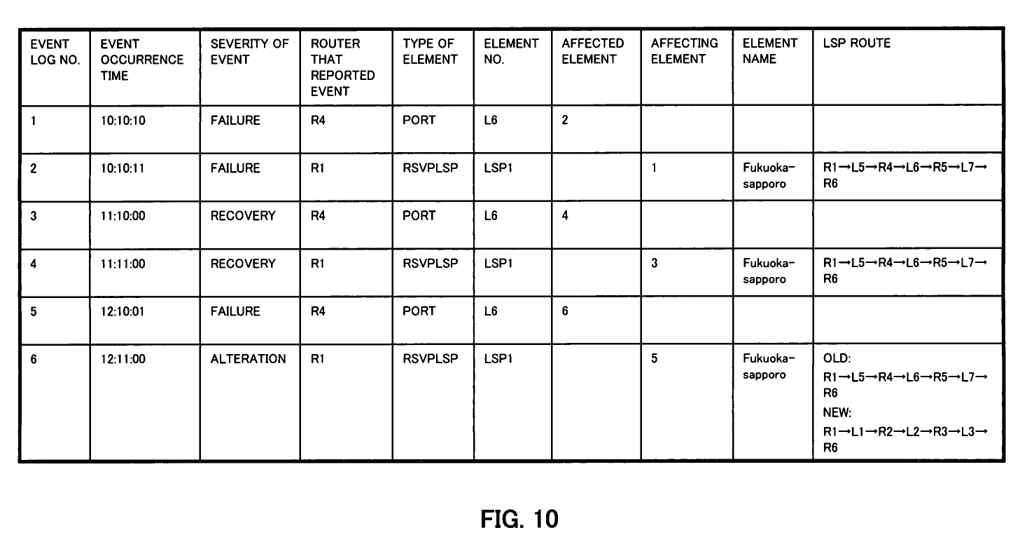

The correlation analyzing section 160 performs correlation analysis in response to a request from the user presentation information creating section 170 in the examples described above. In other examples, the correlation analyzing section 160 can perform correlation analysis upon reception of an event notification by an event notification receiving section 120. In those cases, the log numbers of affecting and affected events can be stored as event information as shown in FIG. 10.

Correlations are analyzed in a manner similar to that described with reference to FIGS. 2 to 4, in order in this case to write the event log numbers of affecting and affected events as shown in FIG. 10 in the event log memory 150. Events on a VPN are omitted from FIG. 10, but correlations among events related to a VPN can also be analyzed in a manner similar to that described with respect to FIGS. 7 to 9. Correlation analysis may be performed in response to an event notification in one of the two methods given below.

One method is to search through events received in the past and stored in the event log memory 150 upon reception of an event notification to find an affecting event that caused the notified event and an affected event that was caused by the notified event. If such an affecting or affected event is found, the log number of the new event just received is written in the entry of the found past event as its affected or affecting event. In addition, an entry for the new event just received is created, and the log number of the affecting or affected event found in the search is written in the entry.

The method described above may place a double processing load because any of the affecting or affected events for the new event just received may not have been received yet. Thus, the other method is to analyze correlations of affecting and affected, at a time, among events that occurred in a given time period that ends at a time point a predetermined amount of time earlier than the current time. The log numbers of events obtained as a result are written in existing entries in the event log memory 150. This process is repeated at predetermined intervals. The predetermined amount of time may be determined on the basis of a typical time that elapses between reception of a causal event and reception of an affected (secondary) event.

The method described with reference o FIGS. 2 to 4 in which analysis is performed in response to a request from the user presentation information creating section 170 places less total load because the analysis is performed on events related to the request, but requires some time to return the result to the user because the analysis is started after reception of the request. On the other hand, the method described with reference to FIG. 10 in which correlations about all events are analyzed and the results are stored while event notifications are being received at the event notification receiving section 120 can quickly provide response to the user, but continually places load for performing correlation analysis. The user (network administrator) may select one of these methods, which is suitable for use, on a case-by-case basis according to the situation. Alternatively, the designer of the monitoring apparatus 100 may have chosen one of the methods and preprogrammed the chosen one in the monitoring apparatus 100.

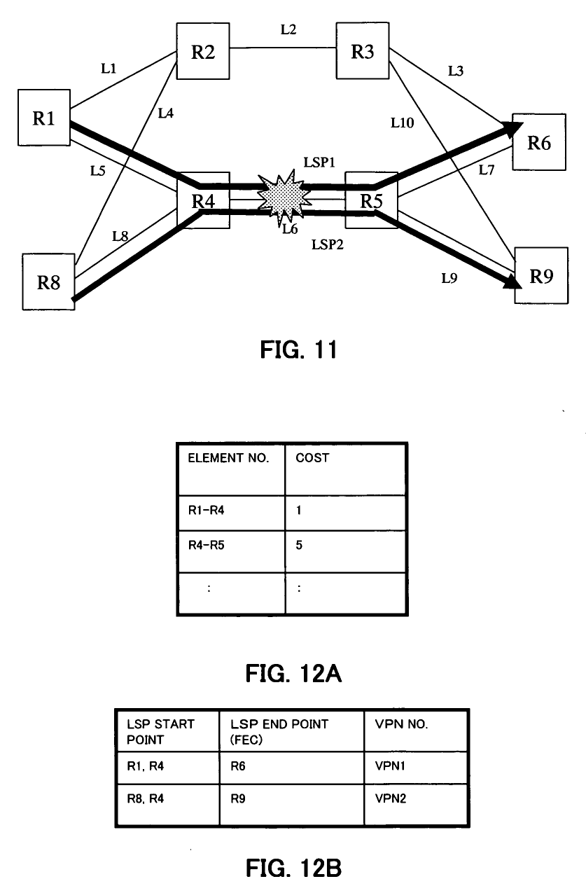

Referring to FIGS. 11 to 14, as components of the network 300, examples will be described in which correlation analysis is performed on a link (port), an IP route, and an LSP established using LDP, in response to an instruction from the user presentation information creating section 170 to search the event log memory 150. It will be understood that the examples are also applicable to a case where correlation analysis is performed on reception of an event notification by the event notification receiving section 120.

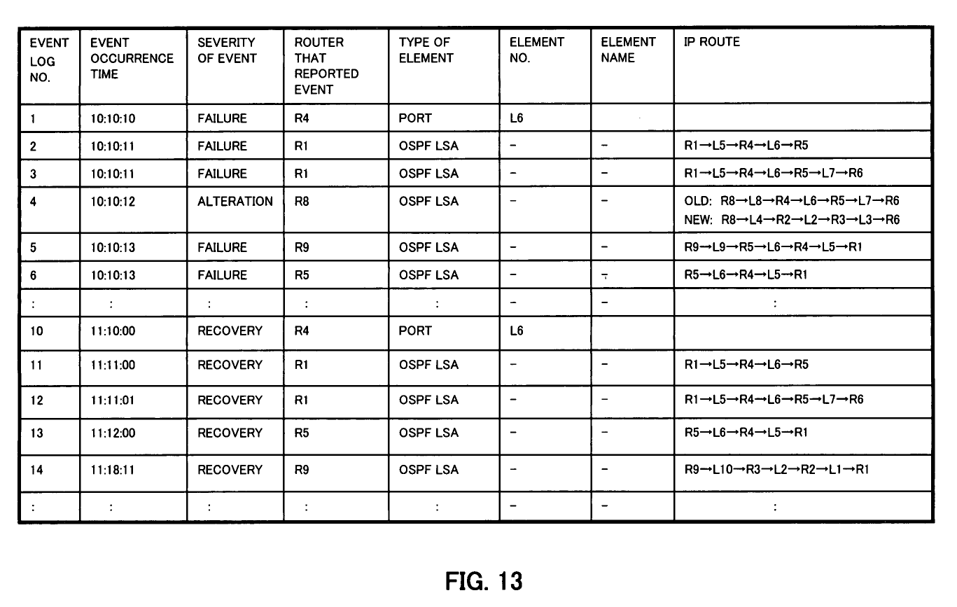

First, an example in which a link (port) and an IP route (a type of logical path) are handled will be described with reference to FIGS. 12A and 13. The network topology in this example is the same as that shown in FIG. 11, except that the LSPs are not established.

In the examples shown in FIGS. 11 to 14, information exchanged using a routing control protocol such as OSPF or IS-IS is collected from the nodes in the network and stored in the logical path information memory 140. Information about OSPF and IS-IS includes information about network topologies. For OSPF, LSA (Link State Advertisement) information represents the network topology information, and includes information about pairs of neighboring nodes and cost of links that interconnects the neighboring nodes as shown in FIG. 12A. Although omitted from FIG. 12A, information about costs of all links (L1 to L10) shown in FIG. 11 is stored. Examples of methods for computing an IP route on the basis of topology information include Dijkstra's computing method and the method disclosed in United States Patent Application Publication No. 2005/0232230, which also makes mention of provision of a collecting apparatus on a network for collecting OSPF and IS-IS information. The monitoring apparatus 100 may serve as the collecting apparatus.

A case where a failure has occurred on link L6 that interconnects routers R4 and R5 will be considered here as shown in FIG. 11. First, router R4 notifies the failure event on link L6 to the monitoring apparatus 100, which then stores the event with log number 1 as shown in FIG. 13.

When the notification of the link failure event is received, the correlation analyzing section 160 computes routes for all possible combinations of start-point routers and end-point routers on the basis of topology information shown in FIG. 12A that is stored in the logical path information memory 140 at the time of the notification received. If any one or more of the computed routes includes the failed link, the correlation analyzing section 160 determines that some event(s) has occurred on the IP route(s), and adds the pair(s) of the start-point and end-point routers of the IP route(s) to an influence list (not shown) provided separately from the event log table shown in FIG. 13. The correlation analyzing section 160 creates a new entry in the event log memory 150 and writes event information about the IP route(s) for which it is determined that a failure occurs, including information about the computed route in the entry. A pointer to the influence list may also be written in the link failure event entry.

In the example in FIG. 11, R1, R5, R6, R8, and R9 are start-point/end-point routers, for the convenience of explanation. After the routes are computed for all possible pairs and the IP routes that include the failed L6 are written in the event log memory 150, the entries with log numbers 2 to 9 in FIG. 13 will result. A mere part of IP routes written in the log memory are shown in FIG. 13. While the start-point routers of IP routes are registered as “Router that reported event” for convenience in FIG. 13, failure/alteration events on IP routes are not reported from the start-point routers but instead are detected by the monitoring apparatus 100 on the basis of topology information it collected. Also, the “Event occurrence time” does not represent the time at which the notification is received or the time is written in the notification. The time at which the monitoring apparatus 100 finds that the LP path includes the failed link by computation is written. The type of element is shown as OSPF-LSA. The element number and name are not given because the process is internally performed in the monitoring apparatus 100.

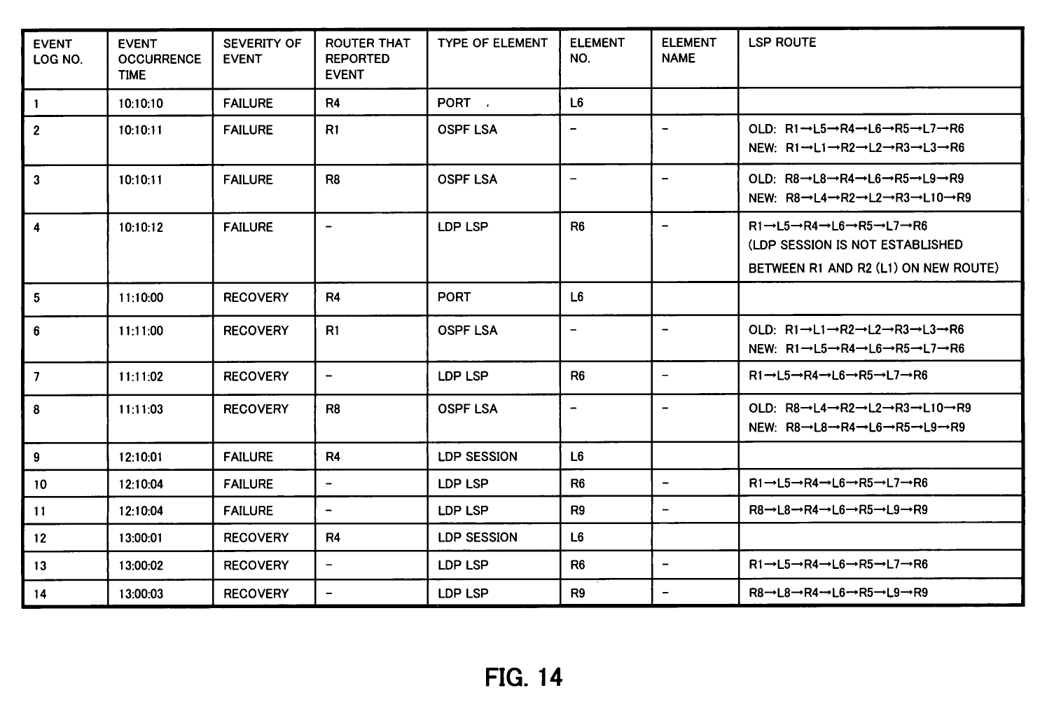

If an alternate route to be used when an intermediate link is down is provided in the network, new OSPF or IS-IS information is obtained by the logical path information obtaining section 130. An alternate route is computed for each pair of start-point and end-point routers registered on the influence list, on the basis of the obtained new topology information. For IP routes for which alternate routes cannot be obtained, the type of event is “failure” as described above and information about the old routes is written in their entries in the event log memory 150 (event entry log number 2, 3, 5, and 6 in FIG. 13). For IP routes for which alternate routes have been obtained, the type of the event is “alteration”, and information about the new routes, in addition to the old routes, is written in their entries in the event log memory 150 (event log number 4 in FIG. 13). However, an alternate route is often changed back to the former route after a link failure is recovered, and thus the event of changing to an alternate route can be considered as a “failure” and the event of returning to the former route a “recovery”. Therefore, the type of an event on IP route for which an alternative route has been obtained may be set as “failure,” instead of “alteration.” In the example in FIG. 14, which will be described later, the type of such an event is set as “failure.”

After the failure on L6 is recovered, router R4 notifies the recovery event on L6 to the monitoring apparatus 100 and the event with log number 10 is stored as shown in FIG. 13. Then new OSPF or IS-IS information is obtained by the logical path information obtaining section 130. The correlation analyzing section 160 computes routes for the pairs of start-point and end-point routers registered on the influence list, on the basis of the new topology information shown in FIG. 12A stored in the logical path information memory 140. New entries are created in the event log memory 150. If a recovery event is found to have happened on an IP route, event information such as computed route information is written for the IP route. Some IP routes found to have failed may be recovered with the same route as before (see records with event log numbers 2 and 11, 3 and 12, and 6 and 13 in FIG. 13) and others with a different route (see records with event log numbers 5 and 14 in FIG. 13). In the example in FIG. 13, the IP route from R8 to R6 changed on the occurrence of the failure on L6 (event log number 4 in FIG. 13) has not been changed back to the former route (the new route is still set) as a result of route computation performed on the recovery from the failure on L6. Accordingly, it is not found that a recovery event has occurred on the IP route, and a recovery is not written in the event log memory 150. After the process is completed for all pairs of start-point and end-point routers registered on the influence list, the influence list is cleared, where no active events remain.

After a notification of a failure event on a link is received, new OSPF or IS-IS information is obtained by the logical path information obtaining section 130. A route may be computed for each of the pairs of the start-point and end-point routers registered on the influence list on the basis of the new topology information when the new topology information is obtained, regardless of whether a notification of a recovery event on the failed link has been received or not. If the route has been changed, a new entry may be created in the event log memory 150 as an alteration or recovery event and event information such as the newly computed route may be written in the new entry. The logical path information memory 140 is overwritten with the new topology information obtained. In the event log memory 150, the old route information is stored in association with a failure event, the new route information is stored in association with a recovery event, and both old and new route information are stored in association with an alteration event. Thus, for each event, route information at the time point at which the event has occurred is stored.

After information as shown in FIG. 13 is thus stored in the event log memory 150, correlations can be analyzed and presented to the user in a manner similar to that described with reference to FIGS. 2 to 9. Though logical path events on IP routes alone have been shown in the example of FIG. 13, an event notification on an RSVP-LSP, if received, can also be stored together in the event log for correlation analysis, of course. Furthermore, in the above-described example, IP routes are computed to determine on which IP route a secondary event has occurred when occurrence of an event on a link (port) is reported to the monitoring apparatus 100. Therefore, the event log numbers of affecting and affected events can be readily written when occurrence of events on IP routes are written in the event log memory 150, similarly to the example in FIG. 10.

Referring to FIGS. 12A, 12B and 14, an example will be described next in which a link (port) and an LSP (a type of logical path) established using LDP are handled. The network topology in this example includes LSPs established as shown in FIG. 11.

The example in FIGS. 11 to 14 (LDP-LSP) differs from the example in FIGS. 2 to 4 (RSVP-LSP) in that event information on an LSP is normally not provided from the start-point router of the LSP to the monitoring apparatus 100 in case of the LDP-LSP. Furthermore, for an LDP-LSP, the start-point router of an LSP typically does not have routing information about the LSP.

The differences are referable to settings of LDP-LSP. Whereas control messages in RSVP related to each LSP are exchanged between the start node and the end node, control messages in LDP related to plural LSPs are exchanged between neighboring nodes in one session. Since an FEC (Forwarding Equivalence Class) exchanged in LDP messages represents an end node of an LSP, the FEC can be stored as an LSP identifier in the column “Element number” in the event log memory 150. Furthermore, since a multipoint-to-point LSP from plural start nodes to a single end node can be established according to LDP, LSP start nodes may not be uniquely identified. Therefore, the “Router that reported event” in the event log memory 150 is blank for LDP-LSP.

Since the route of an LDP-LSP is determined by IP route information (for example information shown in FIG. 12A) exchanged using a routing control protocol such as OSPF or IS-IS, a change of an LDP-LSP route can be detected by monitoring for a change in information exchanged using the IP routing control protocol. For LDP-LSP, an LSP cannot be considered to be established from the start-point node to the end-point node unless control sessions (LDP sessions) between all neighboring nodes on an IP route from the start-point node to the end-point node are established. By monitoring for an LDP session between neighboring nodes on an IP route obtained as described above, failure and recovery events on an LSP can be detected.

Furthermore, by collecting information exchanged using LDP or BGP, information about LSPs can be obtained as shown in FIG. 12B. In the example of FIG. 12B, information indicating which VPN uses which LSP has been also collected. The IP routing information and LSP information are collected by the logical path information obtaining section 130 and stored in the logical path memory 140. Information about LDP-LSP can be collected via the method described in United States Patent Application Publication No. 2005/0220030.

A case where a failure has occurred on link L6 that interconnects routers R4 and R5 will be considered here as shown in FIG. 11. In this example, a failure or a route alteration will occur on the routes LDP-LSP 1 (R1→R4→R5→R6) and LDP-LSP 2 (R8→R4→R5→R9) using L6.

First, router R4 reports a failure event on link L6 to the monitoring apparatus 100, which then stores the event with log number 1 shown in FIG. 14. Upon receiving the notification of the failure event on the link, the correlation analyzing section 160 computes the routes of at least the pairs of start-point and end-point routers indicated in the LSP information in FIG. 12B, on the basis of topology information shown in FIG. 12A that is currently stored in the logical path information memory 140. In the example in FIG. 12B, the IP routes are computed for router pairs (R1, R6), (R3, R6), (R8, R9), and (R4, R9).

Alternatively, IP routes may be computed for all possible pairs of start-point and end-point routers, among which a pair (start-point router, end-point router) having all LDP sessions between neighboring routers on its route established may all be listed, in order to detect an LSP that has been established even if information about a VPN that uses the LSP has not been collected. In the case of (R1, R6) for example, if LDP sessions are established between R1 and R4, between R4 and R5, and between R5 and R6, it means that an LSP from R1 to R6 is established.

If any of the routes between (start-point router, end-point router) thus obtained includes the failed link, it is determined that some event has occurred on the LDP-LSP. Thus, a new entry is created in the event log memory 150 and a failure event on the IP route (OSPF-LSA) is recorded (events with event log numbers 2 and 3 in FIG. 14). Here, the start-point routers of the IP routes are registered as “Router that reported event” for convenience although they do not actually report, and the times at which the routes have been calculated or the event occurrences have been determined by the monitoring apparatus 100 are recorded as “Event occurrence time” for convenience, as explained in the example in FIG. 13.

If alternate routes to be used when an intermediate link is down are provided in the network, new OSPF or IS-IS information is obtained by the logical path information obtaining section 130. In such a case, an alternate route is computed for each of pairs of start-point and end-point routers whose original routes include the failed link, on the basis of the obtained new topology information. For an IP route for which an alternate route can be obtained, information about the new route is recorded in the entry in the event log memory 150 in addition to information about the old route (events with event log numbers 2 and 3 in FIG. 14).

For an IP route for which an alternate route cannot be obtained, it is determined that a failure has occurred on the LDP-LSP established along the route, and a new entry is created in the event log memory 150 into which a failure event on the LDP-LSP is recorded.

For an IP route for which an alternate route has been obtained, determination is made as to whether LDP sessions are established between all neighboring nodes on the new route. If any of them does not have an LDP session established, an LDP-LSP is not established along the new route and therefore a failure event is recorded for the LDP-LSP (event with event log number 4 in FIG. 14). If all LDP sessions have been established, an LDP-LSP is established along the new route, and thus no failure is recorded for the LDP-LSP, or an event may be recorded as an alteration on the LDP-LSP. In the example in FIG. 11, it is determined that an LSP is not established on the alternate route R1→R2→R3→R6 of LSP 1 because an LDP session between R1 and R2 is not established, and that an LSP is established on the alternate route R8→R2→R3→R9 of LSP 2.

After the failure on L6 is recovered, router R4 reports the recovery event on the L6 to the monitoring apparatus 100, where the event with log number 5 in FIG. 14 is stored. New OSPF or IS-IS information is obtained by the logical path information obtaining section 130. The correlation analyzing section 160 computes a route for each of the IP routes (OSPF-LSA) for which a failure event is recorded on the basis of the new topology information shown in FIG. 12A stored in the logical path information memory 140, creates a new entry in the event log memory 150 to record a recovery event (events with event log numbers 6 and 8 in FIG. 14). If an alternate route has been established while a failure is active, there has been an old route and therefore information about both of the old and new routes are written in the entry in the event log memory 150.

For each IP route (OSPF-LSA) on which a recovery event has occurred, determination is made as to whether LDP sessions are established between all neighboring nodes on the new route. If any of the neighboring nodes does not have an LDP session established, an LDP-LSP is not established along the new route and therefore a failure event is recorded for the LDP-LSP. If LDP sessions are established between all neighboring nodes, an LDP-LSP is set along the new route. In the latter case, if a failure event has been recorded for the same LDP-LSP (the event with event log number 4 in FIG. 14), a recovery event is recorded for the LDP-LSP (the event with event log number 7 in FIG. 14). If a failure event has not been recorded for the same LDP-LSP but the route has been changed, an alteration event may be recorded.

If a failure has occurred in the LDP session between routers R4 and R5, router R4 reports the failure event to the monitoring apparatus 100 with the type of element, LDP session, and the element number, L6, and thus the event with log number 9 in FIG. 14 is stored.

If an LDP session on a link between neighboring nodes on an IP route goes down, the monitoring apparatus 100 determines that communications on all LDP-LSPs that pass through the link are discontinued. LDP-LSPs that use the failed link can be identified on the basis of IP routes computed by using topology information in FIG. 12A and on whether LDP sessions are established on each route as described above. In this example, the monitoring apparatus 100 creates new entries in the event log memory 150 and records failure events for all LDP-LSPs that pass through L6 (the events with event log numbers 10 and 11 in FIG. 14).

If the LDP session on link L6 is recovered later, router R4 reports the recovery event to the monitoring apparatus 100 with the type of element, LDP session, and the element number, L6. Thus, the event with the log number 12 in FIG. 14 is recorded.

After an LDP session on a link between neighboring nodes on an IP route is up, the monitoring apparatus 100 computes all IP routes that pass through the link using topology information shown in FIG. 12A as described above. The monitoring apparatus 100 then determines whether all LDP sessions have been established in segments other than the segment in which the LDP session is up. If so, the monitoring apparatus 100 determines that the LDP-LSP along the IP route has been recovered. In this example, the monitoring apparatus 100 creates new entries in the event log memory 150 and records, as recovery events on the LDP-LSP, recovery events for IP routes that pass through L6 and on which LDP sessions between all neighboring nodes are up on the routes (the events with event log numbers 13 and 14 in FIG. 14).

In this way, an event occurrence on an LDP-LSP can be detected based on both of the information about IP routes, obtained via a protocol such as OSPF, and the information about LDP sessions. In addition, by comparing the result with the logical path use information in FIG. 12B, an affected VPN can be identified. In the example in FIG. 14, the downtime from the time at which a failure event on LDP-LSP 1 (log number 4) or its causal event, a failure event on link L6 (log number 1), occurred to the time at which LDP-LSP 1 has recovered (log number 7) can be notified to VPN 1. Similarly, the downtime from the time at which a failure event on LDP-LSP 2 (log number 11) or its causal event, a failure event on the LDP session (log number 9), occurred to the time at which LDP-LSP 2 recovered (log number 14) can be notified to VPN 2.

After information as shown in FIG. 14 is thus stored in the event log memory 150, correlations can be analyzed and presented to the user in a manner similar to that described with reference to FIGS. 2 to 9. Other operations described with respect to FIG. 13 can be performed for the example in FIG. 14 as well. If event logs on OSPF-LSAs and event logs on LDP sessions are stored, events on LDP-LSPs do not necessarily need to be stored in the event log memory 150 because they can be obtained subsequently from those event logs when correlations are analyzed.

As has been described above, by means of the monitoring apparatus 100, elements can be searched in the order of physical interface (port), link, LSP, to VPN (i.e., from physical to logical) or in reverse (from logical to physical). Through the search, secondary events including affected VPNs (customers/services) can be found starting from a causal event (e.g., physical element) or a causal event can be found starting from a secondary event (e.g., logical element).

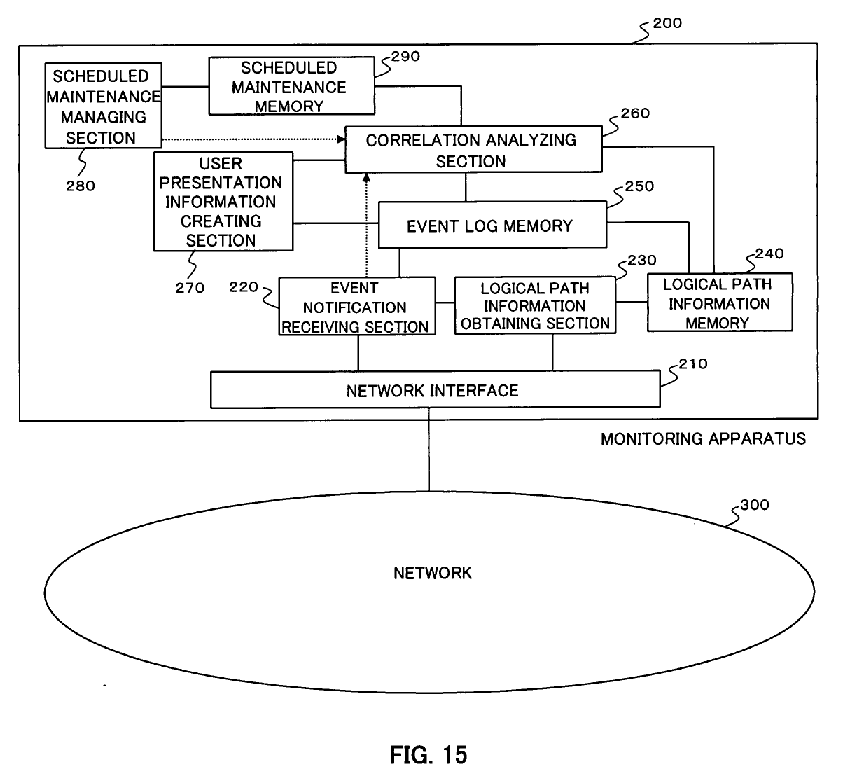

FIG. 15 shows an exemplary internal configuration of a monitoring apparatus 200 having the function of managing scheduled maintenances consistent with the invention. The monitoring apparatus 200 is the same as the monitoring apparatus 100 shown in FIG. 1, except that a scheduled maintenance managing section 280 and a schedule maintenance memory 290 are added. The following description will focus on differences of the monitoring apparatus 200 from the monitoring apparatus 100. The other operations and functions can be the same as those described with respect to the monitoring apparatus 100.

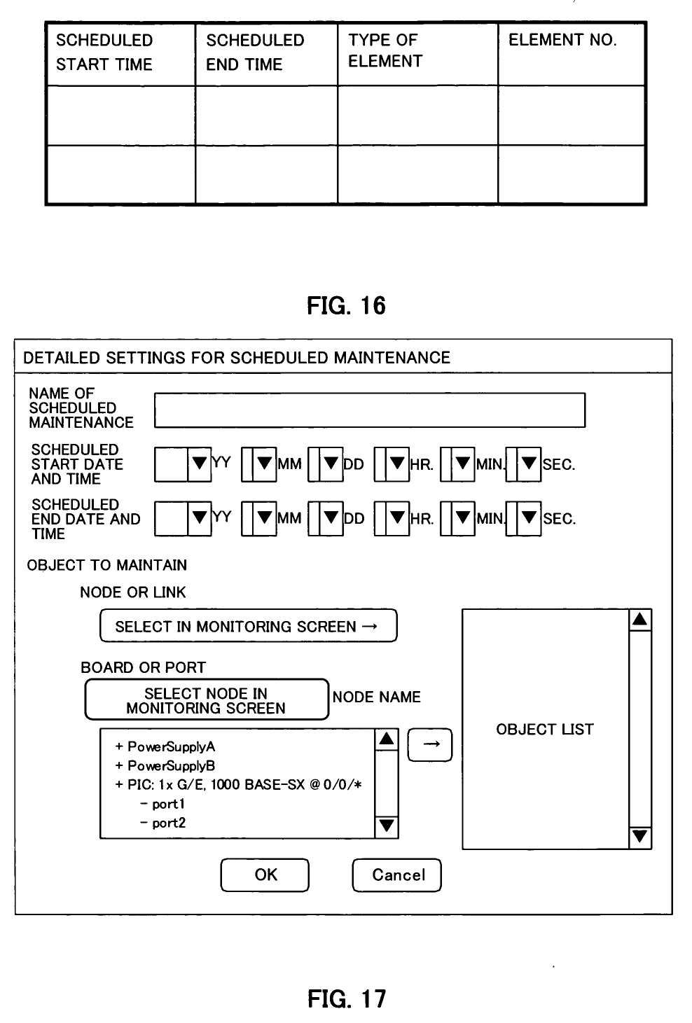

The scheduled maintenance managing section 280 stores information about scheduled maintenances in the scheduled maintenance memory 290 as shown in FIG. 16. The information can be inputted by a user in advance through a scheduled maintenance presetting screen as shown in FIG. 17. The scheduled maintenances stored in the scheduled maintenance memory 290 in this example are maintenances of physical elements. The term “physical” refers to such elements as nodes (network devices), links (lines in-between), ports and/or boards in network devices. Specifically, a user selects a physical object and inputs the scheduled start and end dates and times of a maintenance on the selected object in the scheduled maintenance presetting screen of FIG. 17.

Whereas information about only physical scheduled maintenances is stored in the scheduled maintenance memory 290, event notifications on logical paths are also received in an event notification receiving section 220. Whether an event notification on the logical path has been caused by a scheduled maintenance or not is determined based on the information about physical scheduled maintenances and the information about the logical path stored in a logical path information memory 240. For example, if a “link” is registered as a place of a scheduled maintenance, a failure in the registered link is considered to be attributable to the scheduled maintenance and failures in IP routes such as LSPs that pass through the link and/or failures in elements related to services such as VPNs that use the IP routes are classified as a group caused by the scheduled maintenance.

This classification is performed by a correlation analyzing section 260. In one method, when the event notification receiving section 220 receives an event notification, the correlation analyzing section 260 analyzes correlation to obtain an affecting or causal event of the received event and determines whether the received event or the obtained event is registered in the scheduled maintenance memory 290 as a scheduled maintenance. If so, a user presentation information creating section 270 marks event information to be presented to a user and/or event information stored in an event log memory 250 as a scheduled maintenance event.

In another method, when the scheduled maintenance managing section 280 reports to the correlation analyzing section 260 that a scheduled maintenance has been started as scheduled, the correlation analyzing section 260 analyzes correlation to obtain secondary events that are to be spawned by the event registered as the scheduled maintenance and temporarily stores the obtained events. When the event notification receiving section 220 receives a notification on any of the temporarily stored events, the correlation analyzing section 260 marks the received event as a scheduled maintenance event. If a change is made to logical path information after the scheduled maintenance has started, the correlation analyzing section 260 reanalyzes correlation concerning the changed logical path information and changes the temporarily stored events because the secondary events can possibly become different.

FIG. 18 shows an example of information generated by the user presentation information creating section 270 and displayed on a display screen in order to present notified events and scheduled maintenances that caused the notified events, and/or to present scheduled maintenances and notified events that were spawned by the scheduled maintenances, for a user.

The scheduled maintenances have been registered in advance. Then, information indicating which scheduled maintenances have caused current events (active events) (problems that have not been recovered) is displayed. Also, information indicating which active events are caused by scheduled maintenances is displayed. In the example in FIG. 18, when information is displayed based on active events, active events that are not related to scheduled maintenances are also displayed, and active events related to scheduled maintenances are displayed along with the scheduled maintenances that cause the active events, respectively. When information is displayed based on scheduled maintenances, active events related to the scheduled maintenances are selectively displayed.

While the relation between active events and their corresponding scheduled maintenances is displayed in the example in FIG. 18, the relation between past events and their corresponding scheduled maintenances can also be displayed. FIG. 19 shows such another example in which the past events stored in the event log memory are presented to a user. In the example of FIG. 19, information generated by the user presentation information creating section 270 and displayed on a display screen is a list of selected ones of the past events as related to a finished scheduled maintenance. Reversely to the example of FIG. 19, a list of the past events can be displayed, and in response to a specification of an event on the list, a scheduled maintenance that caused the specified event can be displayed.

The scheduled start and end dates and times of maintenances are inputted and stored as information about the scheduled maintenances in the examples in FIGS. 16 and 17, but in another example, scheduled end dates and times can be omitted. Whereas maintenances are started as scheduled in most cases, they are often finished earlier or later than the scheduled end dates and times, depending on the actual maintenance work progress.

Scheduled end dates and times may be managed in any of the three ways described below, for example. In a first method, scheduled end date and time of a maintenance are inputted and stored, and then the monitoring apparatus 200 automatically treats the maintenance work as having been finished on the scheduled date and time. This method has the advantage that the user is required to input the end date and time only once. In a second method, the scheduled end data and time are inputted and stored, and when the actual maintenance work has been finished, the user also inputs the actual end date and time. This method has the advantage that more accurate relation between an event and the scheduled maintenance can be obtained due to the use of actual end date and time. In a third method, the scheduled end date and time are neither inputted nor stored, and when the actual maintenance work has finished, the user inputs the date and time. The user may input date and time through a keyboard and mouse, or the user may press a scheduled maintenance completion button, for example, thereby registering the current date and time.

Methods and systems relating to failure prediction consistent with the invention will be described below. For example, if one link fails, failure notifications on the ports of the nodes at both ends of the link are to arrive. Similarly, if a link fails, failure notifications on all LSPs that pass the link are to arrive. Furthermore, if an LSP fails, failure notifications on all entities that use the LSP are to arrive. If such failure notifications do not arrive, possibly normal operation has not been performed due to some cause such as a bug of a router.

One way to address such a situation is to notify a user of an abnormal condition in that possibly normal operation has not been performed due to a router bug or the like, if a failure notification that are to be received in relation to a particular failure does not arrive. Another way is to poll a node that is to send a failure notification if the failure notification does not arrive, thereby determining the status of the node. The two methods can be combined to notify the user of an abnormality in a case where a reply to polling is not returned.

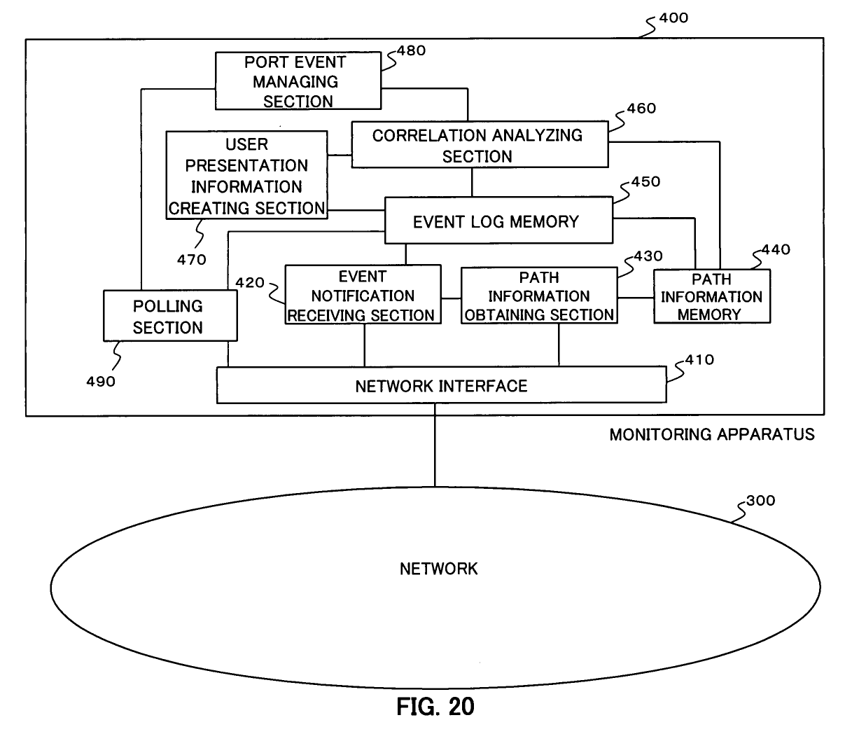

FIG. 20 shows an exemplary internal configuration of a monitoring apparatus 400 having the capability of predicting a failure consistent with the invention. The monitoring apparatus 400 includes a port event managing section 480 and a polling section 490 in addition to the same components as those of the monitoring apparatus 100 in FIG. 1. The polling section 490 can be omitted if presentation of an abnormal condition to the user is enough.

A path information obtaining section 430 and a path information memory 440 do not need to obtain or store information about logical paths such as LSPs for predicting failures on the ports, but may obtain and store the information about logical paths as in the monitoring apparatus 100 for predicting other failures. A correlation analyzing section 460 of the monitoring apparatus 400 predicts an event notification that is to arrive in the future, but may include the function of analyzing correlation between event notifications already received as in the monitoring apparatus 100. The following description will focus on differences of the monitoring apparatus 400 from the monitoring apparatus 100. The other operations and functions can be the same as those described with respect to the monitoring apparatus 100.

As shown in FIG. 21, a link includes two ports connecting to routers. If a notification of a failure on one port arrives, a notification of a failure on the other port should also arrive. If only a failure notification on one of the ports arrive, it is presumed that the failure notification on the other may have been lost on the way because an SNMP trap is not resent even if it has not arrived in operating on UDP, which is an unreliable communication protocol, or a router that is to send a failure notification may have failed. The same applies to recovery notifications.

FIGS. 22 to 24 show an example in which a failure on a port is predicted. FIG. 22A is an example of information about link-port association stored in a path information memory 430 of the monitoring apparatus 400. FIG. 23 shows an example of event information stored in an event log memory 450. The information stored in the path information memory 430 is collected by a path information obtaining section 430 or an event notification receiving section 420 from a network 300 and indicates that the ports of the nodes at both ends of link L6, for example, are (R4, p1) and (R5, p2). Information stored in the event log memory 450 is about events indicated by notifications received by the event notification receiving section 420 from nodes in the network 300, which may include information about port failure/recovery events and/or RSVP-LSP events.

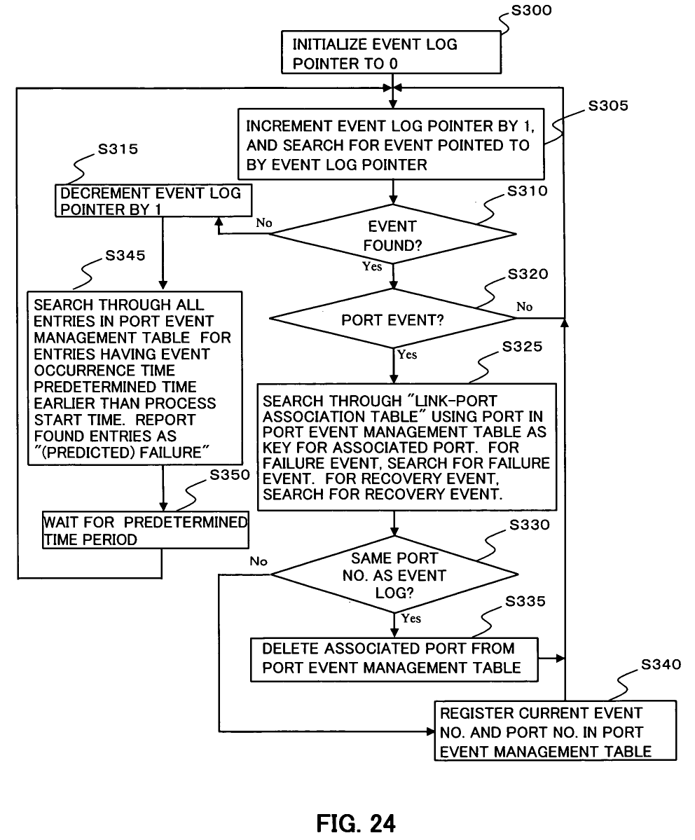

The correlation analyzing section 460 and the port event managing section 480 of the monitoring apparatus 400 performs a failure prediction process at regular intervals as shown in the flowchart of FIG. 24, for example. An event log pointer is initialized to 0 during initialization (S300). The correlation analyzing section 460 has the function of retrieving event information having a log number indicated by an event log pointer from the event log memory 450.

First, the event log pointer is incremented by 1 and an event with the log number indicated by the pointer is searched for (S305). If the event is found in the event log memory 450 (FIG. 23) (S310: Yes), the column “Type of element” is referenced to determine whether the event is on a port or not. If it is an event on a port (S320: Yes), a management table managed in the port event managing section 480 is referred to (S325). Because initially no information is contained in the table (S330: No), a log number of the event indicated by the current event log pointer and an identifier of the port (“Router that reported event” and “Element number”) are registered in the port event management table (S340). FIG. 22B shows an exemplary port event management table, in which a port identifier (R4, p1) of an event with log number 1 which is a failure event on a port is registered.

Then, the event log pointer is incremented by 1 and an event with the log number indicated by the pointer is searched for (S305). If the event is found in the event log memory 450 (FIG. 23) (S310: Yes) and it is an event on a port (S320: Yes), the management table managed in the port event managing section 480 is referred to (S325). That is, a port (for example “R4, p1”) registered in the port event management table (FIG. 22B) is used as a key to search a link-port association table (FIG. 22A) stored in the path information memory 440 to find another port (for example “R5, p2”) associated with the port registered in the port registered management table (FIG. 22B). Here, if the event pointed to by the current event log pointer is a failure event, a port whose log number indicates a failure event among the ports registered in the port event management table is used as a key; if the event indicated by the current event log pointer is a recovery event, a port whose log number indicates a recovery event among the ports registered in the port event management table is used as a key.

If the port found as a result of the search through the link-port association table matches the port identifier of the event indicated by the current event log pointer (S330: Yes), it shows that a failure (or recovery) notification on one of the ports has been successfully received after a failure (or recovery) notification on the other port was received. Accordingly, the entry of the associated port is deleted from the port event management table (FIG. 22B) (S335). This step is reached if the network is in a normal condition. For example, if the event log pointer is 2, the port identifier (R5, P2) of the event with log number 2 matches the port found as a result of search of the link-port association table and therefore the entry of the associated port (R4, p1) is deleted from the port event management table.

If the port found as a result of the link-port association table search does not match the port identifier of the event indicated by the current event log pointer (S330: No), it shows that a failure (or recovery) notification on a new port has been received. Accordingly, the log number of the event indicated by the current event log pointer and the port identifier are registered in the port event management table (S340). That is, if a port identifier is registered in the port event management table, it means that the event notification on the associated port has not yet been received.

After the process descried above is performed for all events stored in the event log memory 450, the event log pointer is incremented by 1. Then, search for the event having the log number indicated by the pointer (S305) does not find an event (S310: No). Therefore, the event log pointer is decremented by 1 (S315) and the entries in the port event management table are searched through (S345). In the example shown in FIG. 23, a recovery event on the port (R5, p3) associated with the port (R4, p1) indicated with event log number 3 has not been received. Accordingly, the entry with log number 3 and port (R4, p1) remains in the port event management table.

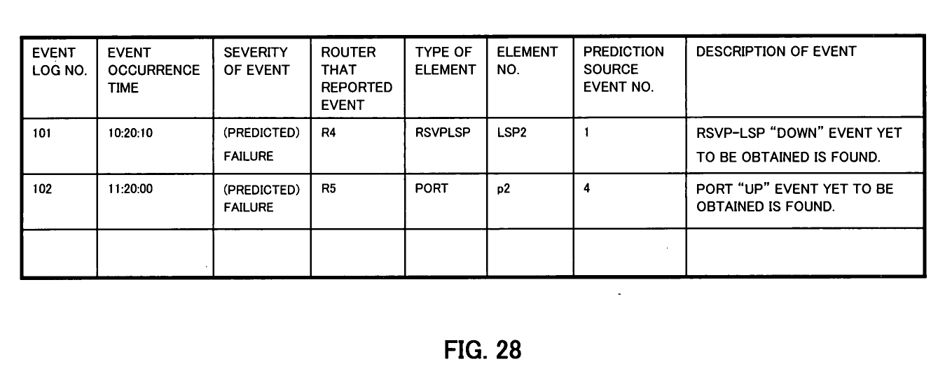

Specifically, the event log memory 450 is referenced, and the entry of an event that occurred before a reference point of time, which is a predetermined time period earlier than the time at which the process has started (or than the current time), is searched for among the events on ports registered in the port event management table. If an entry of such an event is found, it means that the event notification on the associated port has not been received for a given time period or longer. Therefore, the user is notified that there is a possibility of an abnormality relating to the associated port. The abnormal condition may be notified to the user by immediately activating a user presentation information creating section 470 to display a warning or by storing the abnormal condition in the event log memory 450 as an event of the type “(predicted) failure” as shown in FIG. 28, which will be described later, and displaying it as shown in FIGS. 5 and 6 or 18 and 19. As with the case of not receiving a failure event notification, the case of not receiving a recovery event notification can be treated as an event of the type “(predicted) failure.” After completion of the process for notifying the user, there is a given waiting time period (S350), and then the whole process described above is performed for events that are stored in the event log memory 450 during the waiting period.

In the example in FIG. 21, two RSVP-LSPs that pass through link L6 are established. If a failure notification on a port (link) arrives, basically failure notifications (or alteration notifications) on all LSPs that pass through the link should arrive. If any of the failure notifications does not arrive, it is presumed that the failure notification is likely to have been lost on the way or a failure is likely to have occurred on a router that should send the failure notification. Similarly, if a recovery notification on a port (link) arrives, basically recovery notifications on all LSPs that were passing through the link and the routes of which have not been changed should arrive.

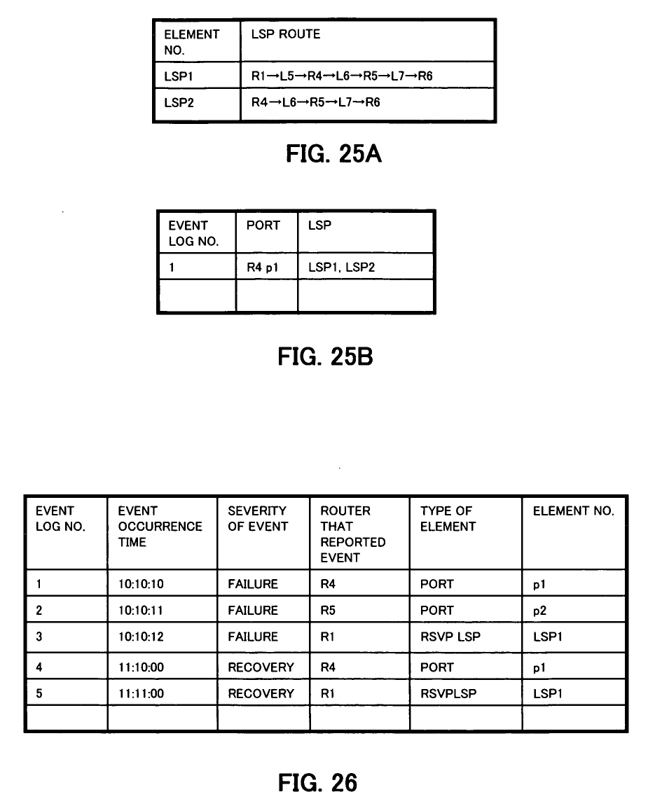

FIGS. 25 to 27 show an example in which failure prediction relating to an LSP is performed. FIG. 25A shows an example of LSP route information stored in the path information memory 430 of the monitoring apparatus 400. Information to be stored in the path information memory 430, which is collected by the path information obtaining section 430 or the event notification receiving section 420 from the network 300, indicates for example that the route of RSVP-LSP 1 is R1→R4→R5→R6 and the route of RSVP-LSP 2 is R4→R5→R6.

FIG. 26 shows an example of event information stored in the event log memory 450. Information stored in the event log memory 450 is port failure/recovery events and RSVP-LSP failure/recovery events indicated by notifications received by the event notification receiving section 420 from nodes in the network 300.

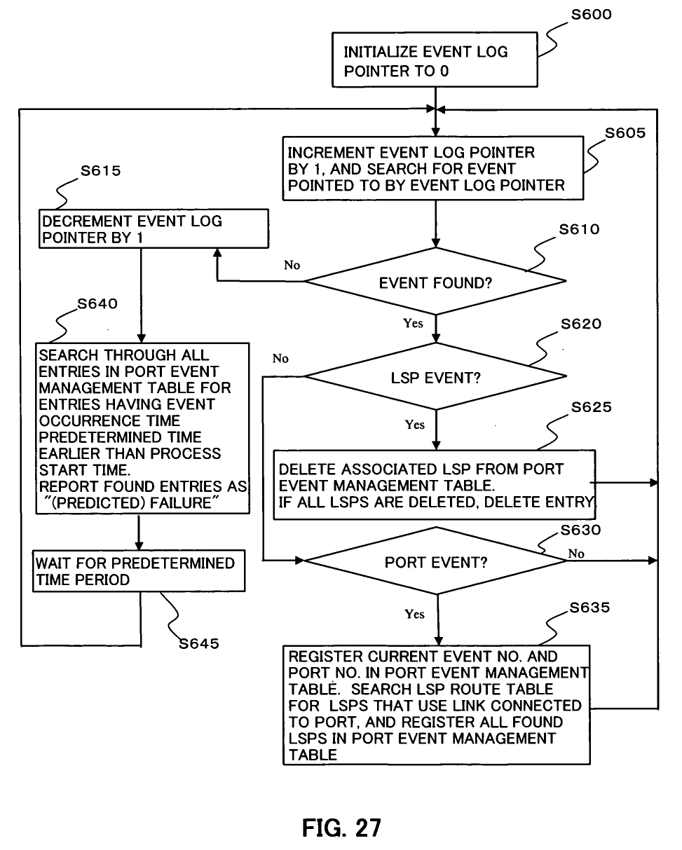

The correlation analyzing section 460 and the port event managing section 480 of the monitoring apparatus 400 repeats a failure prediction process as shown in the flowchart of FIG. 27 at regular intervals. During initialization, the event log pointer is initialized to 0 (S600). The correlation analyzing section 460 has the function of searching the event log memory 450 for event information having a log number indicated by the event log pointer.

First, the event log pointer is incremented by 1 and the event with the log number indicated by the pointer is searched for (S605). If the event is found in the event log memory 450 (FIG. 26) (S610: Yes), the column “Element type” is referenced to determine whether the event is on an LSP. If not (S620: No), whether it is an event on a port is determined. If so (S630: Yes), the log number of the event and the identifier of the port (“Router that reported event” and “Element type”) indicated by the current event log pointer are registered in a management table managed in the port event managing section 480 (S635).

When a port is registered in the port event management table, the LSP route table (FIG. 25A) stored in the path information memory 440 is searched to find all LSPs that pass through the port (link) and their LSP identifiers are registered. FIG. 25B shows an example of the port event management table, in which event log number 1, port identifier (R4, p1), and LSP 1 and LSP 2 that use the port (link) are registered.

Then, the event log pointer is incremented by 1 and the event having the log number indicated by the pointer is searched for (S605). If the event is found in the event log memory 450 (FIG. 26) (S610: Yes), and it is an event on an LSP (S620: Yes), the port event management table is searched for the entry containing the identifier of the LSP (S625). Here, if the event indicated by the current event log pointer is a failure (or an alteration) event, an entry containing a failure event as the port event with the log number registered in the port event management table is searched for; if the event indicated by the current event log pointer is a recovery event, an entry containing a recovery event as the port event with the log number registered in the port event management table is searched for.

Then, the LSP identifier of the event indicated by the current event log pointer is deleted from the found entry in the port event management table. After all LSP identifiers contained in one entry of the port event management table are deleted, the entry is deleted. For example, if the event log pointer is 3, LSP 1 of the two LSPs, LSP 1 and LSP 2, registered in the port event management table is deleted because the LSP identifier of the event with log number 3 is LSP 1. While not received in the example shown in FIG. 26, if a failure event notification on LSP 2 is received from the start node R4, LSP 2 remaining in the port event management table is also deleted and the entry with log number 1 whose LSP column has become empty is deleted from the port event management table.

After the process described above is performed for all events stored in the event log memory 450, the event log pointer is incremented by 1. Then, search for the event with the log number indicated by the pointer (S605) does not find an event (S610: No). Therefore, the event log pointer is decremented by 1 (S615) and the entries of the port event management table are searched through (S640).

Specifically, the event log memory 450 is referenced, and the entry of an event that occurred before a reference point of time, which is a predetermined time period earlier than the time at which the process has started (or than the current time), is searched for among the events registered in the port event management table. If an entry of such an event is found, it means that the event notification on the LSP contained in the entry has not been received for a given time period or longer. Therefore, the user is notified that there is a possibility of an abnormality relating to the associated port. The abnormal condition may be notified to the user by immediately activating a user presentation information creating section 470 to display a warning or by storing the abnormal condition in the event log memory 450 as an event of the type “(predicted) failure” as shown in FIG. 28, which will be described later, and displaying it as shown in FIGS. 5 and 6 or 18 and 19.

After completion of the process for notifying the user, there is a given waiting time period (S645), and then the whole process described above is performed for events that have been stored in the event log memory 450 during the waiting period.

FIG. 28 shows an example in which an abnormal condition detected as described above has been stored in the event log memory 450 as an event of the type “(predicted) failure”. In the example in FIG. 26, a failure event on LSP 1 (log number 3) has been received in relation to the failure event on link L6 (port “R4, p1” or “R5, p2) indicated by log numbers 1 and 2, whereas a failure event on LSP 2 has not received. Therefore, a “(predicted) failure” event on LSP 2 is stored as an event with log number 101 (FIG. 28). The router R4, start-point node of the RSPV-LSP, which should send the notification of the event, is recorded as the “Router that reported event”. The “Event occurrence time” is recorded for convenience, which may be the time at which the process in FIG. 27 (for example S640) was executed or may be the time a predetermined time period after the time at which the event (log number 1) that is a source of the failure prediction occurred. The log number of the event that is a source the failure prediction is also recorded. Description of the event (see the displays in FIGS. 5 and 6) is “RSVP-LSP DOWN event yet to be obtained is found”.

In the example in FIG. 26, since a recovery event on the other port (R5, p2) has not been received in relation with the recovery event on port (R4, p1) (link L6) indicated by log number 4, a “(predicted) failure” event on port (R5, p2) is also recorded with log number 102 (FIG. 28). The router R5 that should send a notification of the event is stored as the “Router that reported event”. Log number 4 is stored as the event that is a source of the failure prediction. Description of the event (see the displays in FIGS. 5 and 6) is “Port UP event yet to be obtained is found”.

“(Predicted) failure” events stored in the event log memory 450 as shown in FIG. 28 can be displayed on a display screen through the user presentation information creating section 470, like events stored as shown in FIG. 26 and events stored in the event log memories 150 and 250. When a recovery event corresponding to a “(predicted) failure” event is reported or inputted, the “(predicted) failure” event becomes a resolved event. Until then, the event is treated as an active event and any of the display methods described with respect to FIGS. 5 and 6 and 18 and 19 can be applied. The event descriptions “RSVP-LSP yet to be obtained” and “Port yet to be obtained” are identified by “element numbers” and can be visualized on a network topology map display as shown in FIG. 2.

In the example described above, determination is made as to whether an event notification concerning an LSP related to a port event notification has received. In another example, determination can similarly be made as to whether an event notification on a port that caused an event notification on an LSP has been received, and further as to whether a notification of an event on another LSP related to the event of the port has been received.

The example has been described with respect to an RSVP-LSP, but apparently the same process can be applied to LDP-LSPs and IP routes (OSPF-LSA). In a configuration in which event notifications about an entity (VPN) that uses a logical path such as an LSP are received, the possibility of an abnormality can be detected by checking whether an event notification concerning a related VPN has been received.

Finally, methods and systems for using failure prediction consistently with the invention will be described. The failure prediction can be used in order to accurately know the current status of a network by polling while reducing the load on the network.

A failure on a network device is typically reported from the network device upon occurrence of the failure by using an SNMP trap. As mentioned earlier, SNMP traps operating under UDP do not always reach their destinations. Therefore, according to conventional methods, a monitoring apparatus polls network elements at regular intervals to compensate this unreliable communication. However, the regular polling places a heavy load on both of the network devices and the monitoring apparatus, which prevents the polling interval from shortened. On the other hand, making the polling interval long delays the discovery of a failure.

This problem can be solved by polling a network device when a failure notification that should be received from the network has not arrived, based on the failure prediction consistent with the invention. As a configuration for this purpose, the monitoring device 400 shown in FIG. 20 can be used.

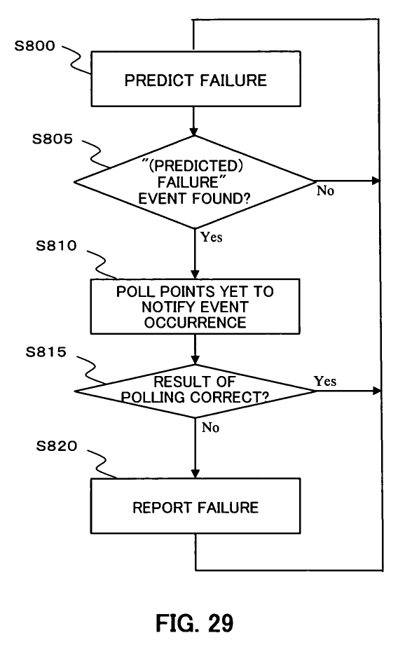

This process can be performed as illustrated in the flowchart shown in FIG. 29. The monitoring device 400 performs failure prediction by repeating the process described with respect to FIG. 24 and/or the process described with respect to FIG. 27 periodically (S800). In response to a writing of a “(predicted) failure” event in the event log memory 450 (S805: Yes) during the failure prediction process, the port event managing section 480 activates the polling section 490, which then polls a network element that should send a failure or recovery event notification that has not yet arrived at the monitoring apparatus 400 (S810).

If a failure notification on a port has not arrived, the polling section 490 polls the node of the port; if a failure notification on an LSP has not arrived, the polling section 490 polls the LSP (for an RSVP-LSP, the polling section 490 polls its start-point node). The polling may be implemented, for example, by sending an SNMP request from the monitoring apparatus to a network element and receiving a reply to it. The polling may be implemented by using CLI (Command Line Interface) or XML (extensible Markup Language) as well.

If a reply to polling is not returned or a reply indicating an error is returned, it is determined that the result of the polling is not successful (S815: No) and it is treated as a failure notification (S820). Specifically, in order to notify the abnormality to the user, the user presentation information creating section 470 may be immediately activated to display a warning, or the abnormality may be stored in the event log memory 450 as a “failure” event and then displayed as an active event as shown in FIGS. 5 and 6 or FIGS. 18 and 19.

Methods and systems consistent with the invention enable a network administrator to grasp at a time a certain event that occurred on an element and a series of secondary events that occurred on other elements due to the certain event and to be aware of customers and services affected. Methods and systems consistent with the invention also allow the network administrator to distinguish related events caused by a scheduled maintenance from the other events at a glance. Furthermore, methods and systems consistent with the invention facilitate the network administrator to take proper actions for a new potential failure by identifying a notification about a related event that should be issued but does not arrive at the monitoring apparatus.

Persons of ordinary skill in the art will realize that many modifications and variations of the above embodiments may be made without departing from the novel and advantageous features of the present invention. Accordingly, all such modifications and variations are intended to be included within the scope of the appended claims. The specification and examples are only exemplary. The following claims define the true scope and spirit of the invention.

What is claimed is:

1. A network monitoring apparatus comprising:
a collecting unit that collects information regarding a packet forwarding path, the path being dynamically established in a network;
a receiving unit that receives a notification indicating that an event has occurred on an element of the network; and
an analyzing unit that analyzes correlation between a plurality of notifications received by the receiving unit, on the basis of the information collected by the collecting unit.

2. The network monitoring apparatus according to claim 1, wherein
there is at least one of a failure, a failure recovery, and an alteration on the element, as types of events indicated by notifications received by the receiving unit.

3. The network monitoring apparatus according to claim 1, wherein
the analyzing unit uses information regarding a packet forwarding path that can be presumed to have been used when the event occurred, on the basis of a time identified by the notification received by the receiving unit, among information regarding the packet forwarding path at a plurality of times collected by the collecting unit.

4. The network monitoring apparatus according to claim 1, wherein
the analyzing unit analyzes the correlation irrespective of an order in which the plurality of notifications were received by the receiving unit.

5. The network monitoring apparatus according to claim 1, wherein
the collecting unit collects routing information exchanged between nodes in the network, and
the analyzing unit uses the routing information to calculate a packet forwarding path and analyzes the correlation on the basis of the calculated packet forwarding path.

6. The network monitoring apparatus according to claim 1, wherein
the collecting unit collects information regarding a label switched path established in the network, and
the analyzing unit analyzes whether there is correlation between an event concerning a label switched path and an event concerning a link passed through by the label switched path.

7. The network monitoring apparatus according to claim 1, further comprising
a memory that stores information regarding events indicated by notifications received by the receiving unit as a log,
wherein the analyzing unit, in response to a request by a user, analyzes correlation between the events regarding which the log information is stored in the memory, and presents a result of the analysis to the user.

8. The network monitoring apparatus according to claim 1, further comprising
a memory that stores information regarding an event indicated by a notification received by the receiving unit,
wherein the analyzing unit, in response to a reception by the receiving unit, analyzes correlation between the event regarding which the information is stored in the memory and an event indicated by a notification received, and stores a result of the analysis in the memory.

9. The network monitoring apparatus according to claim 1, wherein the analyzing unit comprises:
a unit that identifies, on the basis of the information regarding the packet forwarding path, a notification indicating occurrence of an event causing a series of correlated events among the plurality of notifications; and
a unit that specifies, on the basis of the information regarding the packet forwarding path, an event that secondarily occurs on another element due to occurrence of the causing event.

10. The network monitoring apparatus according to claim 9, wherein
the collecting unit comprises a unit that collects, in addition to the information regarding the packet forwarding path, information indicating an entity that uses the packet forwarding path, and
the analyzing unit comprises a unit that identifies, on the basis of the information indicating the entity, an entity affected by occurrence of the causing event.

11. The network monitoring apparatus according to claim 9, further comprising
a unit that, if the causing event is a failure, estimates a time period during which packets related to said another element on which the secondary event occurs are not transferred, on the basis of a time identified by the notification indicating the occurrence of the causing event.

12. The network monitoring apparatus according to claim 9, further comprising
a unit that presents a notification of the secondary event that occurs on said another element to a user in a form that varies depending on the level of severity of the secondary event.

13. The network monitoring apparatus according to claim 9, further comprising
a unit that, if a notification indicating that the secondary event specified by the analyzing unit to occur on said another element has actually occurred is not received by the receiving unit, presents an abnormal condition to a user.

14. The network monitoring apparatus according to claim 9, further comprising
a unit that, if a notification indicating that the secondary event specified by the analyzing unit to occur on said another element has actually occurred is not received by the receiving unit, checks a status of said another element.

15. A network monitoring apparatus, comprising:
a collecting unit that collects information regarding a packet forwarding path, the path being dynamically established in a network;
a receiving unit that receives a notification indicating that an event has occurred on an element of the network;
a registering unit that registers information indicating that a maintenance of an element in the network is scheduled and a scheduled start time of the maintenance; and
an analyzing unit that analyzes correlation between an execution of the maintenance registered by the registering unit and the event notification received by the receiving unit, on the basis of the information collected by the collecting unit.

16. The network monitoring apparatus according to claim 15, wherein
the analyzing unit comprises a unit that, in response to a reception by the receiving unit, determines whether the execution of the maintenance causes the event indicated by the notification, on the basis of information regarding the packet forwarding path at a time identified from the reception.

17. The network monitoring apparatus according to claim 15, wherein the analyzing unit comprises:
a unit that, in response to a start of the maintenance, specifies an event that secondarily occurs on another element due to the execution of the maintenance, on the basis of information regarding the packet forwarding path at a time identified from the start, and stores the specified event; and
a unit that, in response to a reception by the receiving unit, determines whether the event indicated by the notification is stored as the specified event.

18. A network monitoring apparatus comprising:
a collecting unit that collects information representing interrelation between elements in a network;
a receiving unit that receives a notification indicating occurrence of an event on an element of the network;
an analyzing unit that, on the basis of the information collected by the collecting unit, specifies another notification concerning another element to be received in a case of occurrence of the event indicated by the notification received by the receiving unit; and
a managing unit that detects whether said another notification specified by the analyzing unit is received by the receiving unit within a predetermined time period.

19. The network monitoring apparatus according to claim 18, further comprising
a unit that presents an abnormal condition to a user, if the management unit detects that said another notification has not been received within the predetermined time period.

20. The network monitoring apparatus according to claim 18, further comprising
a checking unit that sends a message for checking a status of said another element onto the network, if the managing unit detects that said another notification has not been received within the predetermined time period.

21. The network monitoring apparatus according to claim 20, further comprising
a unit that, if an abnormality is detected on the basis of a reply to the message sent by the checking unit, notifies a user of the abnormality.

22. The network monitoring apparatus according to claim 18, wherein
the information collected by the collecting unit is at least one of information regarding a set of elements directly interconnected in the network and information regarding a packet forwarding path dynamically established in the network.

23. A network monitoring method comprising:
collecting information regarding a packet forwarding path, the path being dynamically established in a network;
receiving a plurality of notifications, each notification indicating that an event has occurred on an element of the network; and
analyzing correlation between the plurality of notifications received, on the basis of the collected information.

24. A computer usable medium having computer readable program codes embodied therein for a computer functioning as a network monitoring apparatus, the computer readable program codes comprising:
a first program code for collecting information regarding a packet forwarding path, the path being dynamically established in a network;
a second program code for receiving a notification indicating that an event has occurred on an element of the network; and
a third program code for analyzing correlation between a plurality of notifications received by the second program code, on the basis of the information collected by the first program code.

25. The computer usable medium according to claim 24, the computer readable program codes further comprising:
a fourth program code for registering information indicating that a maintenance of an element in the network is scheduled and a scheduled start time of the maintenance; and
a fifth program code for causing the third program code to analyze correlation between a first notification indicating that an event corresponding to the scheduled maintenance registered using the fourth program code has occurred and a second notification indicating that another event has occurred.

26. A network monitoring method comprising:
collecting information representing interrelation between elements in a network;
receiving a notification indicating occurrence of an event on an element of the network;
specifying, on the basis of the collected information, another notification concerning another element to be received in a case of occurrence of the event indicated by the received notification; and
detecting whether said another notification specified is received within a predetermined time period.

27. A computer usable medium having computer readable program codes embodied therein for a computer functioning as a network monitoring apparatus, the computer readable program codes comprising:
a first program code for collecting information representing interrelation between elements in a network;
a second program code for receiving a notification indicating occurrence of an event on an element of the network;
a third program code for obtaining, on the basis of information collected by the first program code, a notification concerning another element to be received in a case of occurrence of the event indicated by the notification received by the second program code; and
a fourth program code for detecting whether another notification specified by the third program code is received within a predetermined time period.

28. The computer usable medium according to claim 27, the computer readable program codes further comprising
a fifth program code for sending a message for checking a status of said another element onto the network, if it is detected by the fourth program code that said another notification has not been received within the predetermined time period.
